(19) United States
(12) Patent Application Publication
(10) Pub. No.: US 2025/0309680 A1
(43) Pub. Date: Oct. 2, 2025

(54) Self-Contained, Modular, Intelligent and Resilient Appliance Nanogrid System

(71) Applicant: Pila Energy, Inc., San Francisco, CA (US)

(72) Inventors: Cole Ashman, San Francisco, CA (US); Eric Wang, Burlingame, CA (US); Nicholas Dunkel, San Francisco, CA (US); Aleksandar Daniel Oleg Rivin, Westminster, CO (US)

(21) Appl. No.: 19/091,735

(22) Filed: Mar. 26, 2025

Related U.S. Application Data
(63) Continuation-in-part of application No. 19/083,668, filed on Mar. 19, 2025.
(60) Provisional application No. 63/569,986, filed on Mar. 26, 2024.
(60) Provisional application No. 63/680,432, filed on Aug. 7, 2024.
(60) Provisional application No. 63/683,114, filed on Aug. 14, 2024.
(60) Provisional application No. 63/689,550, filed on Aug. 30, 2024.

(51) Int. Cl. H02J 9/06; H02J 3/02; H02J 3/38; H02J 13/00

(52) U.S. Cl. CPC H02J 9/062; H02J 3/02; H02J 3/388; H02J 9/068; H02J 13/00022; H02J 2300/26; H02J 2310/14

(57) ABSTRACT

A self-contained nanogrid system comprises a power supply input to couple to an external primary power source within a premises, a switch coupled to connect or disconnect the system from the primary power, and a battery as backup to the primary power source. The system further comprises a DC power bus coupled to the battery, an AC power bus coupled to the power supply input via the switch, and a bidirectional inverter coupled between the AC and DC power buses. The system further comprises an integrated load coupled to receive power from the AC power bus or the DC power bus, a power output to provide power from the AC power bus or the DC power bus to an external load, and a processing unit configured to control operations of the self-contained nanogrid system, including the switch.

This application claims the benefit of:
U.S. provisional patent application No. 63/569,986, filed on Mar. 26, 2024;
U.S. provisional patent application No. 63/680,432, filed on Aug. 7, 2024;
U.S. provisional patent application No. 63/683,114, filed on Aug. 14, 2024; and
U.S. provisional patent application No. 63/689,550, filed on Aug. 30, 2024;

This application is also a continuation-in-part of U.S. patent application Ser. No. 19/083,668, filed on Mar. 19, 2025.

The disclosures of each of the above-referenced applications are incorporated by reference herein in their entireties.

### FIELD

The present disclosure relates to systems and techniques for power generation and energy storage at a premises, and more specifically, to a self-contained, modular, intelligent and resilient appliance nanogrid system.

### BACKGROUND

The growing need for accessible and resilient solutions for backup power and intelligent energy management for homes and businesses is becoming more and more evident. As we continue to move from a carbon-centric model of power supply and generation, with the growing integration of renewable energy sources (some of which are variable based on weather conditions, etc.) on the power grid and the rising frequency of power outages with increased usage, aging infrastructure, and climate-change fueled natural events, there is a critical demand for better energy storage solutions to support the electric grid and enhance system flexibility in a simple, integrated, and controllable manner. During power outages or other events (e.g., reduced power events, spikes, etc.), several common critical power-related issues arise for homes and businesses, including loss of refrigeration to food and medicine presenting health risks, loss of heating ventilation and air conditioning (HVAC) presenting health and comfort risks, loss of domestic hot water supply and risks associated with potable water, loss of function to communication equipment (e.g. LAN, Wi-Fi) presenting challenges staying connected in emergency situations, loss of power to premises security systems, and more. Traditional power backup solutions fall short of sufficiently addressing these problems.

### BRIEF DESCRIPTION OF THE DRAWINGS

FIG. 1a shows an example of a building's electrical system and a nanogrid integrated within it using a plug and receptacle connection method. The diagram details power architecture for the example nanogrid, containing battery energy storage, integrated and user-connected AC and DC loads, and optional external solar photovoltaic and battery storage modules.

FIG. 1b shows an example of a building's electrical system and a nanogrid integrated within it using a fixed wiring connection method to a distribution load center. The diagram details power architecture for the example nanogrid, containing battery energy storage, integrated and user-connected AC and DC loads, and optional external solar photovoltaic and battery storage modules.

FIG. 1c shows an example of a building's electrical system with site-level Distributed Energy Resources (DERs), site-level Microgrid Interconnection Device (MID), and a nanogrid integrated within it using a plug and receptacle connection method. The diagram details power architecture for the example nanogrid, containing battery energy storage, integrated and user-connected AC and DC loads, and optional external solar photovoltaic and battery storage modules.

FIG. 1d shows an example of a building's electrical system and a nanogrid integrated within it using a plug and receptacle connection method. The diagram details power architecture for the example nanogrid, containing battery energy storage, integrated and user-connected AC and DC loads, optional external solar photovoltaic and battery storage modules, and an integrated load which may be selectively switched between the AC or DC bus within the nanogrid.

FIG. 2a is a system-level block diagram showing functional elements of an on-board compute system of a nanogrid system.

FIG. 2b is a system-level block diagram showing a nanogrid system with modular attachments for power, communication, and processing modules.

FIG. 3 is a system-level block diagram showing examples of software-controlled interactions between nanogrid system(s) and both on-premises and remote software systems.

FIG. 4 depicts a logic state diagram of the nanogrid system's Microgrid Control System (MCS) software-defined intentional islanding behavior, as would be used to provide seamless backup power to loads associated with the nanogrid system.

FIG. 5a shows an example of the operational mode and power routing strategies taken by the nanogrid and its Energy Management System (EMS) software, in relation to the utility grid and other systems connected to premises electrical distribution system, where the system is grid-connected with net power import, with an AC-coupled solar system producing excess power to supply power to AC loads, to charge an example central energy storage system, and to supply power to the nanogrid system to charge the battery and supply its loads.

FIG. 5b shows an example of the operational mode and power routing strategies taken by the nanogrid and its Energy Management System (EMS) software, in relation to the utility grid and other systems connected to premises electrical distribution system, where the system is grid-connected with net power import, with both and AC-coupled and DC-coupled solar system producing excess power to supply power to AC building loads, and to supply power to the nanogrid system to charge the battery and supply its loads.

FIG. 5c shows an example of the operational mode and power routing strategies taken by the nanogrid and its Energy Management System (EMS) software, in relation to the utility grid and other systems connected to premises electrical distribution system, where the system is grid-connected with net power export, with a DC-coupled solar system producing excess power to supply power to AC loads, and to supply power to the nanogrid system to charge the battery and supply a select set of its DC loads.

FIG. 5d shows an example of the operational mode and power routing strategies taken by the nanogrid and its Energy Management System (EMS) software, in relation to the utility grid and other systems connected to premises electrical distribution system, where the system is grid-connected with net power export, with the onboard energy storage discharging to supply power to AC loads, and to supply power to the nanogrid system to supply a select set of its DC and AC loads.

FIG. 5e shows an example of the operational mode and power routing strategies taken by the nanogrid and its Energy Management System (EMS) software, in relation to the utility grid and other systems connected to premises electrical distribution system, where the system is grid-connected with zero net power flow to the building electrical system, with a DC-coupled solar system producing power along with onboard battery discharging, to supply power to the nanogrid's DC and AC loads.

FIG. 5f shows an example of the operational mode and power routing strategies taken by the nanogrid and its Energy Management System (EMS) software, in relation to the utility grid and other systems connected to premises electrical distribution system, where the system is grid-connected with zero net power flow to the building electrical system, with the onboard battery discharging, to supply power to the nanogrid's DC and AC loads.

FIG. 5g shows an example of the operational mode and power routing strategies taken by the nanogrid and its Energy Management System (EMS) software, in relation to the utility grid and other systems connected to premises electrical distribution system, where the system is islanded from the building electrical, with a DC-coupled solar system producing power along with onboard battery discharging, to supply power to the nanogrid's DC and AC loads.

FIG. 5h shows an example of the operational mode and power routing strategies taken by the nanogrid and its Energy Management System (EMS) software, in relation to the utility grid and other systems connected to premises electrical distribution system, where the system is islanded from the building electrical, with onboard battery discharging to supply power to the nanogrid's DC and AC loads.

FIG. 5i shows an example of the operational mode and power routing strategies taken by the nanogrid and its Energy Management System (EMS) software, in relation to the utility grid and other systems connected to premises electrical distribution system, where a central building microgrid system is islanded from the utility grid, with net power import to the nanogrid system from an AC-coupled solar system and central energy storage system providing power to supply power to the building's AC loads, and to supply power to the nanogrid system to charge the battery and supply its loads.

FIG. 5j shows an example of the operational mode and power routing strategies taken by the nanogrid and its Energy Management System (EMS) software, in relation to the utility grid and other systems connected to premises electrical distribution system, where a central building microgrid system is islanded from the utility grid, with net power import to the nanogrid system from an AC-coupled solar system and central energy storage system providing power to supply power to the building's AC loads, along with DC-coupled solar production at the nanogrid to supply power to the nanogrid system to charge the battery and supply its loads.

FIG. 5k shows an example of the operational mode and power routing strategies taken by the nanogrid and its Energy Management System (EMS) software, in relation to the utility grid and other systems connected to premises electrical distribution system, where a central building microgrid system is islanded from the utility grid, with net power export from the nanogrid system and central energy storage system providing power to supply power to the building's AC loads, along with DC-coupled solar production at the nanogrid to supply power to the nanogrid system to supply nanogrid loads.

FIG. 5m shows an example of the operational mode and power routing strategies taken by the nanogrid and its Energy Management System (EMS) software, in relation to the utility grid and other systems connected to premises electrical distribution system, where a central building microgrid system is islanded from the utility grid, with net power export from the nanogrid system and central energy storage system providing power to supply power to the building's AC loads, along with nanogrid battery discharging to supply power to the nanogrid system to supply nanogrid loads.

FIG. 6 is a flowchart illustrating operations carried out by a nanogrid system, related to energy management behaviors and interaction with other on-premises energy systems.

FIG. 7 is a logic state diagram of the Appliance Management System (AMS) software providing anomaly detection and failure prediction for connected loads within and attached to the nanogrid system.

FIG. 8a is a flowchart diagram describing inputs and outputs of software functions carried out by the Thermal Management System.

FIG. 8b is a flowchart of a process for maintaining the system's software-defined thermal and operational setpoints and limits.

FIG. 8c is a flowchart of a process of selecting between operational modes wherein a load to the Thermal System may be modified based on energy source(s) and storage.

FIG. 9a1 shows an example of a strategy for exchanging heat between an interior refrigerated compartment of the nanogrid appliance system and the internal battery and power modules within the system, where the primary method for heat transfer is via a thermal conductance through a cold plate or thermally conductive heatsink block.

FIG. 9a2 shows an example of a strategy for exchanging heat between an interior refrigerated compartment of the nanogrid appliance system and the internal battery and power modules within the system, where the primary method for heat transfer is via an internal heat duct and air blower assembly.

FIG. 9a3 shows an example of a strategy for exchanging heat between an interior refrigerated compartment of the nanogrid appliance system and the internal battery and power modules within the system, where the primary method for heat transfer is via a single internal loop to pump a thermal fluid to shuttle heat from one sub system to another.

FIG. 9a4 shows an example of a strategy for exchanging heat between multiple interior refrigerated compartments of the nanogrid appliance system and the internal battery and power modules within the system, where the primary method for heat transfer is via an internal loop to pump a thermal fluid to shuttle heat from one sub system to another, along with a secondary auxiliary loop allowing for selective routing of the thermal fluid from the battery module.

FIG. 9b1 shows an example of a strategy for exchanging heat between the system and battery and power modules within the system and an evaporator module within the system's refrigeration loop, where the primary method for heat transfer is via a thermal conductance through a cold plate or thermally conductive heatsink block.

FIG. 9b2 shows an example of a strategy for exchanging heat between the system and battery and power modules within the system and an evaporator module within the system's refrigeration loop, where the primary method for heat transfer is via a single internal loop to pump a thermal fluid to shuttle heat from one sub system to another.

FIG. 9b3 shows an example of a strategy for exchanging heat between the system and battery and power modules within the system and an evaporator module within the system's refrigeration loop, where the primary method for heat transfer is via an internal heat duct and air blower assembly.

FIG. 10a depicts an example of an architecture of a nanogrid system leveraging airflow to manage temperature of battery and power electronics modules.

FIG. 10b depicts an example of an architecture with a controllable auxiliary loop of the refrigeration symptom to manage temperature of battery and power electronics module(s).

FIG. 10c depicts an example of an architecture expanding on FIG. 10b to include an additional closed thermal loop for heat exchange between battery and power electronics module(s) and other compartments of the system.

FIG. 10d depicts an example of an architecture expanding on FIG. 10c to include a heated water tap system.

FIG. 10e depicts an example of an architecture with two closed refrigeration loops.

FIG. 10f depicts an example of an architecture leveraging a reversing valve to alternate between providing cooling and heating functionality, along with a strategy for managing heat exchange to battery and power electronics module(s).

FIG. 10g depicts two example of an architectures leveraging controllable open-loop fluid flow heat exchange with battery and power electronics module(s).

FIG. 11a is a flowchart of a process performed by the Thermal Management System (TMS) providing selective cooling to battery energy storage and power electronics modules.

FIG. 11b is a flowchart of a process performed by the TMS providing selective defrost heating to refrigeration compartments leveraging system waste heat.

FIG. 12a is a flowchart of a process of the nanogrid system to manage remote power requests, such as for Virtual Power Plant (VPP) or Demand Response (DR) events.

FIG. 12b is a flowchart of a process of the Energy Management System (EMS) to optimize energy usage from various sources such as grid, microgrid, solar, and battery energy storage.

FIG. 13a is an example system diagram of the nanogrid system's AC and DC power architectures for a simple appliance with a refrigeration loop, showing power routing within the nanogrid system between AC supply, internal battery energy storage, user-connected AC and DC loads, integrated DC loads, and low-voltage DC components and sensors.

FIG. 13b is an example system diagram of the nanogrid system's AC and DC power architectures for an appliance with one or more refrigeration loops, showing power routing within the nanogrid system between AC supply, internal battery energy storage, user-connected AC and DC loads, integrated AC and DC loads, low-voltage DC components and sensors, as well as solar photovoltaic inputs and internal solar MPPT converters connected to the internal DC bus.

FIG. 13c is an example system diagram of the nanogrid system's AC and DC power architectures for an appliance with one or more refrigeration loops, showing power routing within the nanogrid system between AC supply, internal battery energy storage, user-connected AC and DC loads, integrated AC and DC loads, low-voltage DC components and sensors, as well as solar photovoltaic inputs and internal solar MPPT converters and user-replaceable battery energy storage modules connected to the internal DC bus.

FIG. 13d is an example system diagram of the nanogrid system's AC and DC power architectures for a heat pump appliance, showing power routing within the nanogrid system between AC supply, internal battery energy storage, user-connected AC and DC loads, integrated AC and DC loads, low-voltage DC components and sensors, as well as solar photovoltaic inputs and internal solar MPPT converters and user-replaceable battery energy storage modules connected to the internal DC bus.

FIG. 14a1 is a front-facing isometric view of an integrated nanogrid system that includes a refrigeration appliance.

FIG. 14a2 is a front-facing isometric view of the integrated nanogrid system of FIG. 14a1, illustrating an example of how an aesthetic cover may be added.

FIG. 14a3 is a front-facing isometric view of the integrated nanogrid system of FIGS. 14a1 and 14a2, illustrating how one or more photovoltaic panels and/or loads can be connected to the integrated nanogrid system.

FIG. 14a4 is a front-facing isometric view of an integrated nanogrid system such as shown in FIGS. 14a1-14a3, but with one or more dispensable water taps in its front door.

FIG. 14b shows a rear-facing isometric view of the integrated nanogrid system of FIGS. 14a-14a3 or FIG. 14a4.

FIG. 15a shows a front-facing, isometric, cut-away view of an integrated nanogrid system that includes a water heater.

FIG. 15b shows a front-facing, isometric view of the integrated nanogrid system of FIG. 15a, showing how one or more photovoltaic panels, loads and/or batter storage modules can be connected to the integrated nanogrid system.

FIG. 16a shows a front-facing, isometric, cut-away view of an integrated nanogrid system that includes a water heater a window unit air conditioner or heat pump.

FIG. 16b shows a front-facing, isometric view of the integrated nanogrid system of FIG. 16a, showing how one or more photovoltaic panels, loads and/or batter storage modules can be connected to the integrated nanogrid system.

FIG. 17 depicts an in-situ isometric view of an example embodiment in which the integrated nanogrid system is designed to provide heating, ventilation, and air conditioning (HVAC) in a “mini-split” form factor, including the connection of optional solar photovoltaic panels.

FIG. 18a is a front-facing isometric view of an integrated nanogrid system that includes a clothes washer and/or dryer.

FIG. 18b is a front-facing isometric view of the integrated nanogrid system of FIG. 18a, illustrating an example of how an aesthetic cover may be added.

FIG. 18c is a front-facing isometric view of the integrated nanogrid system of FIGS. 18a and 18b, illustrating how one or more photovoltaic panels and/or loads can be connected to the integrated nanogrid system.

### DESCRIPTION

Traditional backup generators fall short of addressing the above-mentioned needs and problems, as they lack intelligent software-controlled features for supporting the electric grid and rely on fossil fuels, making them unsustainable and less adaptable to modern energy requirements. Backup generator systems generally are not able to provide additional software-enabled energy management or data insights valuable to the occupant.

Existing solutions such as rooftop solar photovoltaic (PV) and building-integrated battery energy storage systems (BESS) are often prohibitively expensive, requiring specialized labor for installation and complex permitting processes which have slowed adoption at scale. These product solutions are optimized for integration with single-family detached homes, making them less suitable for other building styles, such as multi-family or commercial properties. Furthermore, portable battery power stations (e.g. camping batteries with AC output) are low-cost and convenient but are not designed for grid interoperability, are not optimized for integration within the built environment, and lack the necessary compute and software capabilities to integrate with building systems and appliances. These portable solutions are intended for off-the-grid use and are not suitable for standard grid-connected homes and businesses where appliances are used in a semi-permanent manner, limiting their value to the electric power system.

The rise of smart appliances enabled by the Internet of Things (IoT) revolution has brought about significant advancements in home automation and energy management. However, aside from smart electric vehicle (EV) chargers and smart thermostats, these devices to date have failed to deliver material grid support value, such as participation in Demand Response (DR) programs. Moreover, current smart appliances do not integrate seamlessly within today's emergent home energy management systems (HEMS) or building management systems (BMS), nor do they coordinate on site-level energy management strategies for high energy and utility bill savings. They also fail to interact with onsite microgrids and generation (like solar PV systems) to monitor and self-report energy usage effectively or alter behavior in support of optimized system-level performance.

The operation of building-integrated, i.e., behind-the-meter (BTM), microgrids presents significant challenges when integrating unmanaged loads, which are indeterminate in their operation, non-interactive, non-communicating, and uncontrolled. These loads can cause microgrid stability issues and design challenges, particularly due to inrush currents at load start-up that exceed the capacity of current-limited safety systems on standard multimode inverters, such as those used in the Tesla Powerwall. While solutions like smart electrical panels partially address this load control need by offering branch-circuit-level power control at the circuit breaker level, they fail to provide granular and appliance-sensitive control. This lack of precise control leads to inefficiencies and potential instability within the microgrid, along with a poor user experience. Without the ability to manage individual appliances, the system cannot optimize energy usage or respond effectively to varying load demands, resulting in increased wear and tear on the infrastructure and reduced overall efficiency. Effective management of loads at the appliance level is crucial for maintaining microgrid stability and achieving the desired energy efficiency and resilience.

Finally, there is a significant opportunity to improve the efficiency, longevity, and interoperability of the appliances in our homes and businesses by innovating on core power systems design. This can be achieved by leveraging direct current (DC) motors, incorporating energy storage, and integrating advanced control systems. By doing so, we can provide better control, flexibility, and efficiency, enabling appliances to operate more intelligently and in harmony with the overall energy system. This approach allows for precise speed control, variable speed operation, and higher starting torque, which are particularly beneficial for optimizing performance and reducing energy consumption. Additionally, the integration of energy storage enables better management of energy supply and demand, ensuring that appliances can continue to operate efficiently even during power outages or periods of high demand. Enhanced interoperability among appliances and the broader energy ecosystem also facilitates seamless communication and coordination, further improving energy efficiency and resilience.

There is a pressing need for the next generation of microgrid and nanogrid solutions to be cost-effective, intelligent, and easily deployable. These solutions should support simple installation, easy scalability, intelligent premises-level energy awareness, and seamless integration within the building's product ecosystem. Such advancements will address the shortcomings of traditional backup power systems and provide the necessary resilience and energy optimization for modern homes and businesses.

Introduced here us a self-contained, modular, intelligent, and resilient appliance nanogrid system designed to revolutionize energy resilience, energy management, and electrical safety within the built environment by enhancing the accessibility, flexibility, efficiency and interoperability of appliances and energy systems in homes and businesses. This system advances power capabilities and intelligence of connected appliances, enabling them with energy storage, solar photovoltaic generation, flexible power conversion, and intentional islanding capabilities to participate in broader energy systems (i.e. behind-the-meter and distribution grid level) and deliver unique value for grid services, energy optimization, and power control. Simultaneously, the system provides seamless backup power to the appliance system and user-connected loads during power outages and events leveraging a flexible AC and DC receptacle system and modular battery design. This system takes an integrated product design approach to battery-based microgrid solutions which uniquely circumvents traditional retrofit design challenges when deploying this technology into a premises' electrical distribution system. Through integration of energy storage and power conversion with loads designed for heating and cooling applications, a highly space and energy efficient design can be achieved through integrated passive and active thermal designs. The system's powerful onboard processing and software systems enable extensive distributed monitoring, control, and integration capabilities within both first- and third-party product ecosystems, delivering energy performance optimization, energy management, nanogrid control, and appliance failure prediction. This functionality is presented with user-friendly interfaces, accessible both on the device and through companion applications (e.g., smartphone, web, televisions, AR/VR, etc.) and APIs (e.g., for integration, use, and display with and/or within other applications), allowing for remote monitoring and configuration. This system is uniquely positioned to reshape the landscape of residential energy and intelligent appliances with the introduction of this economical, adaptable, and smart system designed to manage and supply power to essential home equipment.

The self-contained, modular, intelligent and resilient appliance nanogrid system introduced here is directed toward addressing the accessibility, performance, and interoperability limitations of existing building-integrated battery energy storage systems, BTM microgrids, building electrical loads, and solar PV systems, while enhancing the energy resilience, flexibility, efficiency, monitoring, serviceability, and software integration ability of traditional home appliances. The system creates benefits not realized by modern appliances or modern microgrid systems by combining unique approaches to power system design, integrated thermal management, power conversion, energy management and optimization, microgrid controls, system and environmental monitoring, programmable software logic and networking, and design for integration with home and grid software systems. The system's design provides accessibility by leveraging existing infrastructure and familiar device form factors, thereby simplifying both retrofit and new installation to minimize technology deployment cost and complexity.

In this disclosure, a distinction is drawn between a microgrid and a nanogrid. A “microgrid” is defined herein as a premises wiring system that includes power generation, energy storage and one or more loads, and includes the ability to disconnect (i.e., to intentionally “island”) from and to operate in parallel with the primary source. Microgrids contain some or all of the premises distribution system (e.g., load centers and feeder conductors) to provide broad coverage of the electrical system. As such, a microgrid necessarily contains fixed-in-place (i.e. non-temporary) electrical equipment subject to specific installation and permitting requirements. For a residential microgrid, the primary source is generally considered to be the electric utility grid.

In contrast, a “nanogrid” is defined herein as a self-contained system, designed for operation at a premises (e.g., a home or small business), that may be electrically connected in either a temporary or non-temporary manner and that includes energy storage, connection points for generation, and connection points for one or more loads, and includes the ability to disconnect from and operate in parallel with the premises wiring system (i.e., with the utility grid). A nanogrid has the ability to operate within a microgrid, Hence, one or more nanogrids can exist as nested elements within a premises' microgrid system or may exist in the absence of a larger microgrid system such that all intentional islanding capabilities across the site are limited to each independent nanogrid.

### System Overview

The nanogrid system introduced here may include a power system including alternating current (AC) and direct current (DC) electrical buses at a variety of voltages optimized to the associated AC and DC loads, DC generation, AC sources, and DC storage modules, along with intelligent power conversion circuitry to seamlessly convert between voltages (i.e. DC-DC converters, and DC-AC converters also known as inverters). The power system can be designed for high conversion efficiency and flexibility for a variety of applications. Integrated within the electrical power buses are components for controlling (i.e. with actuators, relays, contactors, switches) and monitoring power to support the system's operation and to provide data inputs for enhancing the capabilities and performance of the overall system. One manner of control is an embedded Microgrid Interconnection Device (MID) to enable the system to safely intentionally island, providing backup power to connected loads via the system's integrated energy storage and energy generation.

The system's integrated thermal system represents a significant improvement to overall energy efficiency and appliance performance. In an integrated system such as this, during operation often one component or area may require increased temperature while another requires decreased temperature, benefiting from a system-level integrated approach to limit energy expenditure to independently optimize the thermal requirements. The thermal system leverages a combination of active and passive strategies to effectively monitor multiple integrated components and areas, and efficiently move heat from one location to another to achieve controlled, localized heating and cooling of these components and areas. The thermal system is designed to utilize a combination of working fluids (e.g. air, coolant, refrigerant) in a combination of open-loop (e.g. with the local ambient environment) and closed-loop exchanges.

A specifically designed compute and programmable software system confers the power and thermal systems with their intelligent capabilities, while adding significant value to overall performance, monitoring, and control. The onboard compute system can include programmable processor(s), memory and software, and embedded electronics designed to effectively integrate these elements. This onboard system is responsible for a variety of hardware-enabled, software-defined functions encapsulated by an energy management system (EMS), power control system (PCS), microgrid control system (MCS), thermal management system (TMS), and appliance management system (AMS), plus communication and interoperability with backend software systems (i.e. Cloud) and on-premises software systems and communication networks (e.g. local area networks, Wi-Fi, Matter)

The system's mechanical design is designed to allow for seamless installation and integration within the built environment, while providing users with intuitive, robust interfaces. Unlike traditional building-integrated battery energy storage systems, this system is capable of semi-permanent or fixed installation akin to appliance systems (e.g. via a standard power receptacle, or via connection to electrical distribution equipment such as a load center). Unlike portable power station batteries, this system is not designed to be transported as part of normal use, but rather to exist in a selected location within the built environment (i.e. be installed in a residence or business). This can be achieved by designing the system with a robust enclosure (e.g., as depicted at 204a-b) containing and hosting the core elements of the nanogrid power system (storage, generation, loads, electrical interconnections, and circuitry), thermal system, compute and communication system, and user interfaces. Specific advantages of this design for semi-permanence include delivering automatic backup power in power outages, energy management with strategies including premises-level energy context, providing automatic current management (i.e. acting as a Power Control System), gathering, and delivering energy and other insights relevant to the specific associated premise.

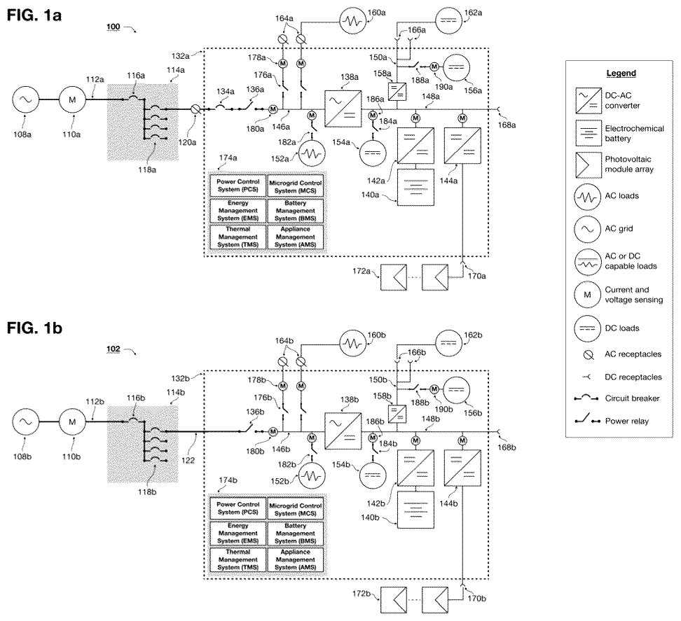

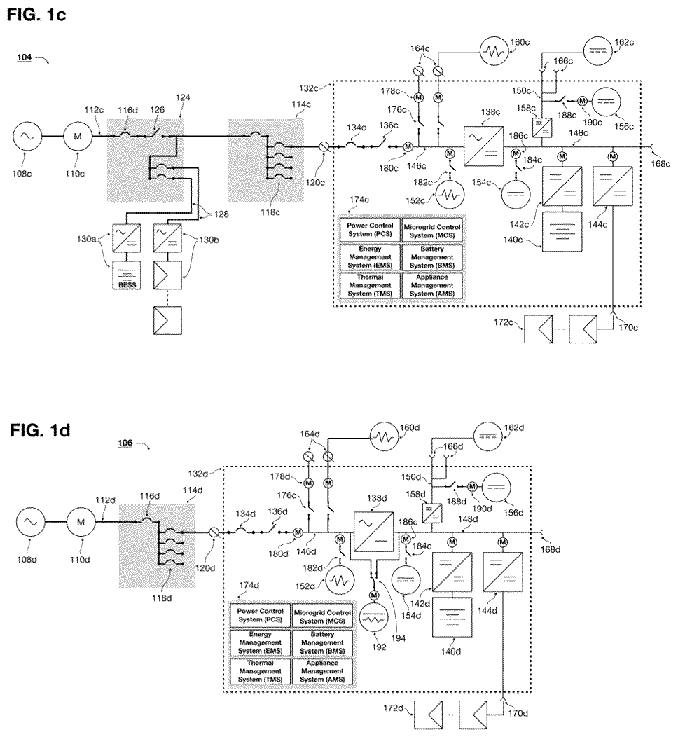

This nanogrid system is designed to be electrically connected at any location within a premises' alternating current (AC) wiring system (i.e., behind the meter) as illustrated in FIGS. 1a-1d. FIGS. 1a-1d show examples of a building's electrical system and different ways in which a nanogrid can be integrated within it. These diagrams detail power architectures for the example nanogrid, containing battery energy storage, integrated and user-connected AC and DC loads, and optional external solar photovoltaic and battery storage modules FIG. 1d further shows an integrated load, in a nanogrid, that may be selectively switched between the AC or DC bus within the nanogrid.

In this context, premises may be considered to be a home, apartment unit, or physical building with an associated and integrated electrical distribution system for which one or more electric utility meters 110a-d is connected to a utility distribution grid 108a-d and is supplied electrical power via AC feeder service conductors 112a-d to a primary electric distribution panelboard or disconnecting components (i.e. the Service Equipment 114a-b, 114d, 124) containing primary overcurrent protection device(s) (OCPDs, also known as circuit breakers) 116a-b, 116d, 126 which in turn feed branch circuits via branch circuit breakers 118a-d. Branch circuits may feed 128 additional electrical panelboards, fixed-in-place loads or sources (i.e. hard-wired, non-temporary loads), or one or more electrical receptacles. In some embodiments, the AC distribution wiring system 100-106 is designed in a split-phase configuration with three current carrying conductors (Line 1, Line 2, and Neutral) having Line-to-Neutral (L-N) voltage of nominally 110˜120 AC volts root-mean-squared (V RMS) and Line-to-Line (L-L) voltage of nominally 110˜120 AC volts root-mean-squared (V RMS). In other embodiments, the AC distribution wiring system is designed in a single-phase configuration with two current carrying conductors (Line 1 and Neutral) having Line-to-Neutral (L-N) voltage of nominally 110˜277 AC volts root-mean-squared (V RMS). In other embodiments, the AC distribution wiring system is designed in a three-phase wye configuration with four current carrying conductors (Line 1, Line 2, Line 3, and Neutral) having Line-to-Neutral (L-N) voltage of nominally 110˜277 AC volts root-mean-squared (V RMS) and Line-to-Line (L-L) voltage of nominally 208˜480 AC volts root-mean-squared (V RMS). In some embodiments, a premises-level microgrid is included in the premises distribution system 104, containing components for islanding (i.e. via an MID) 126 and, in some embodiments, also containing onsite solar photovoltaic (PV) generation device(s) 130b and an onsite centralized battery energy storage system (BESS) 130a.

### Power System Architecture

In some embodiments, nanogrid system 132a-d is electrically connected to premises AC wiring via a power cable containing Line (L), Neutral (N), and Protective Earth (PE) or Ground (GND) conductors connected to an AC power receptacle 120a, 120c, 120d (e.g., NEMA 5-15R, NEMA 5-20R, NEMA 6-15R, NEMA 6-20R, NEMA 6-30R, NEMA 6-50R, NEMA 10-30R, NEMA 10-50R, NEMA 14-20R, NEMA 14-30R, NEMA 14-50R when used in the North American region). In some embodiments, as shown in FIG. 1b, the system's electrical connection to the premises wiring system can be achieved by making a direct-wired connection 122 via a set of branch conductors connected to an overcurrent protection device (OCPD, e.g. circuit breaker) with no intervening power plug and receptacle system.

A component of the nanogrid system design is a DC-to-AC power converter (DCAC) 138a-d, 220 engineered to convert between a common internal high voltage DC (HVDC) bus 148a-d (nominally 300-600 VDC) and a common internal AC bus 146a-d (nominally 110˜277 VAC root-mean-squared L-N). In certain embodiments, the main DCAC is capable of operating in parallel (i.e. having synchronous voltage, frequency, and phase) with the external AC voltage source provided by connection to the premises electrical system. This configuration ability is controlled by an onboard power conversion controller 226 that allows for optional power export to the home/building or a premises microgrid, enhancing the system's versatility and integration with existing energy infrastructure.

In some embodiments, the main DCAC is designed to be bi-directional, enabling it to route current in both directions-AC-to-DC for battery charging and DC-to-AC for powering appliances and/or enhancing power with the building electrical distribution system. This bi-directional functionality supports efficient energy storage management, allowing the onboard battery to be charged from both DC sources and the AC grid. The bi-directional DCAC is also implemented as a hybrid inverter, also known as a multimode inverter, capable of software-defined operating modes in both grid-forming (voltage-forming) and grid-following (voltage-following, current source) modes. This dual-mode operation allows the system to function independently or in synchronization with a grid or premises microgrid, providing seamless transitions between grid-connected and off-grid operation at the nanogrid level. The bi-directional DCAC may be based on various converter topologies, including full-bridge, half-bridge, H-bridge, or multilevel designs, each selected to optimize performance, efficiency, and reliability depending on the specific application.

The DCAC system may be configured for operation at various L-N AC voltages, frequency, and power factors to support regional needs, application needs, and to enable “smart inverter” functions (e.g. as defined in IEEE 1547 and UL 1741 standards) to provide valuable distributed grid services value and Virtual Power Plant (VPP) control. For embodiments targeting refrigeration and freezer applications, the main DCAC outputs single-phase power (e.g., 110˜120 VAC L-N, 230˜240 VAC L-N) to match the AC input of refrigeration appliances, ensuring compatibility and efficiency. In other embodiments such as those targeting HVAC applications, the DCAC is designed to supply split-phase AC power (e.g., 120/240 VAC L-N-L) with corresponding power receptacles, facilitating its use in residential and commercial environments where such configurations are common. The DCAC's power conversion controls are specially designed to effectively handle AC inrush current when inductive loads, such as compressors and motors, are turned on, preventing any overloading of the battery or power conversion circuitry while the system is intentionally islanded.

The system is designed to supply reliable, safe, seamless backup power (i.e. intentional islanding with DCAC in a grid-forming mode) to connected loads, including AC loads, in the event of power loss or power quality issues with the connected premises wiring system. Isolation of the bi-directional hybrid DCAC output (i.e. the common internal AC bus 146a-d) from the nanogrid system's AC supply connection 120a-d, 122 for intentional islanding and safety purposes is managed by an integrated software-controllable grid disconnect relay (i.e. an MID) 136a-d, 222. To manage this set of functions, the system is designed with a MCS 174a-d and MID system for monitoring power and voltage quality, and asserting MID disconnection and reconnection based on a software program within the onboard memory and processor. The MID relay(s) may be of a form designed to simultaneously disconnect only line conductor(s), or of a form designed to simultaneously disconnect line and neutral conductors.

In some embodiments, the nanogrid system contains one or more integrated loads which are designed to be supplied with AC voltage (AC loads, e.g. motors, compressors, fans, lighting, heating elements, pumps, solenoids, transformers, electronic controllers, valves, induction coils) 152a-d, 266, along with one or more AC power receptacles hosted on the nanogrid system 164a-d, 238 to allow users to connect external AC loads 160a-d via a power cable and plug 242. Flexible connection of loads by users is a feature of the nanogrid system, offering users the ability to power essential devices in the event of a grid power outage. These receptacles are also designed for general use irrespective of power outages and are designed to provide convenience, energy metering 178a-d, and control via dedicated software-controlled 174a-d power relays 176a-d, 232. Additionally, some embodiments include outlet-integrated overcurrent protection devices, such as resettable thermal fuses, to enhance safety. Receptacles may be equipped with Ground Fault Circuit Interrupter (GFCI) protection, providing added safety for general use with other AC appliances like countertop appliances. In some embodiments, integrated AC loads are also designed with metering and power control circuitry 182a-d to allow for greater operational insight, power management, and energy management.

The nanogrid system is designed with energy metering circuitry 236 including voltage sensors, current sensors (e.g. a combination of current transformers, shunts, Hall effect sensors, Rogowski coils, resistive current sensors, fluxgate sensors, magnetoresistive sensors), and power metering integrated circuits. Energy and power metering is crucial for the system to accurately monitor and manage energy usage, improve performance, enable efficient operation, and provide valuable data for grid interaction, billing, and load management. In some embodiments, metering points (in particular the point of AC power exchange with the premises wiring system 180a-d) are designed and calibrated for high accuracy (e.g. compliant with standards such as ANSI C12.1 and ANSI C12.20) to provide revenue-accurate monitoring for billing and VPP use cases.

The system's HVDC bus allows for power exchange between the DC-input of the DCAC, DC nanogrid sources, DC energy storage, DC loads, and DC receptacles. DC energy storage (i.e. electrochemical battery module(s)) is another feature of this system, allowing for flexible management and dispatch of energy with or without an external AC source voltage present. The system is designed with one or more DC battery modules 140a-d including battery cells, interconnection, overcurrent protection, battery monitoring circuitry, and a BMS 230 paired with a bidirectional DCDC converter designed to regulate voltage, regulate current, manage battery charging and discharging cycles, and connect the battery system to the common HVDC bus.

The system is designed to host one or more rechargeable battery packs 228 constructed from one or more battery cells—such as Lithium-ion (Li-ion), Lithium solid state, or Sodium-ion (Na-ion) battery cells—for bulk energy storage and to act as a primary power source for the operating the system and supplying power to connected devices. The system is designed such that the battery can source power to the system in the event of an grid/microgrid power outage and/or when the primary AC power source (i.e. the grid/microgrid supply via the building's AC receptacle). Energy storage capacity is designed to maintain a manageable weight and size when integrated within the integrated system, to allow easy installation. The battery is designed with sufficient capacity to source several hours or days of backup power, which can be controlled as needed based on an expected need as specified by a user or power supply company/hardware, and/or as determined by the system based on prior events. In some embodiments targeting refrigerator/freezer/washer/dryer applications, the battery's usable energy capacity is between 1-5 kilowatt-hours (kWh). In some applications targeting HVAC and water heating applications, the battery's usable energy capacity is between 3-10 (kWh). Similarly, battery charging and discharging power and cycle life are tailored to the application. Energy storage capacity and battery sizing and chemistry may vary across embodiments to serve the given appliance-integration application, and may be supplemented by add-on battery module(s).

In some embodiments, the nanogrid system is designed to support the connection of one or more DC generation sources 250, such as external solar PV panels (including PV panel strings or sets of PV panel strings) 172a-d, to provide sustained off-grid operation, local energy management, and energy optimization. The system incorporates one or more Maximum Power Point Tracking (MPPT) circuits 144a-d using either boost or boost/buck converter topology, ensuring efficient energy harvesting. To facilitate easy and flexible deployment, especially in power emergencies, the system features accessible connection points for temporary PV panels, using a system suitably rated touch-safe DC electrical receptacles and connectors 170a-d (e.g. MC4, cigarette jacks, barrel jacks, or other appropriate styles).

In some embodiments, the nanogrid system contains one or more integrated loads 154a-d designed to be supplied with DC voltage (DC loads, such as battery chargers, DC motors, DC compressors, fans, resistive heating elements, LED lighting, DC fans, electronic controllers, sensors) 268-270. Most appliances, including refrigerators, commonly use AC motors due to their lower cost. Inclusion and use of DC loads in this design introduces several advantages over traditional AC appliances. DC motors, particularly brushless DC (BLDC) motors, offer several advantages that make them a compelling alternative including (a) Efficiency: DC motors often exhibit higher efficiency compared to their AC counterparts, largely due to reduced friction losses. This efficiency translates into better performance and energy savings. Moreover, DC motors provide more precise speed control, which can optimize the performance of the compressor and the refrigeration cycle; (b) Control: One of the significant benefits of DC motors is their ability to offer variable speed control. This feature allows the compressor to adjust its speed based on the cooling demand, leading to energy savings and reduced wear and tear on the system. Additionally, the precise speed control of DC motors results in quieter operation, which is highly advantageous in noise-sensitive environments; (c) Torque: DC motors generally deliver higher starting torque, making them beneficial for starting the compressor under load. This high starting torque enables the compressor to start and function efficiently even under demanding conditions and conditions when available supply power is limited (e.g. in an outage, supplied only by battery or solar PV). In some embodiments, LVDC load supply circuits are designed with metering 186a-d and power control circuitry 184a-d to allow for greater operational insight, power management, and energy management.

In some embodiments, one or more internal loads 192 may be designed to be supplied by either the common AC bus or HVDC bus using a switching relay 194. This design allows for flexible power distribution, enabling the system to seamlessly switch between AC and DC power sources based on availability or efficiency considerations. By accommodating both types of power sources, the system can optimize energy usage, enhance reliability, and provide greater adaptability to varying power conditions or requirements. This approach also facilitates integration with a diverse range of internal and external components, ensuring that the system can maintain consistent operation and performance regardless of the power source.

In some embodiments, the system includes one or more connection points 168a-d, 258 to the HVDC bus without an intervening DCDC converter to allow for direct and modular addition of battery modules, solar inputs with MPPT, and DC loads. This design enables straightforward expansion and integration of additional components, facilitating flexible system scaling and simplified connectivity for various energy sources and consumption devices. These connection points are designed for maximum user safety and non-damaging use (e.g. with effective OCPD, touch-safe connectors, reverse polarity protection). The types of connections that may be used include wire pressure screw connectors, blade connectors, plug and receptacle connectors, blind-mate connectors, and other suitably rated and reliable electrical connection methods.

In some embodiments, the system is designed with a low voltage DC (LVDC) bus 150a-d supplied via one or more DCDC buck converters 158a-d connected to the HVDC bus. This LVDC bus supports a common low voltage system, which supplies power to various components such as communications and compute units 174a-d, control units, LVDC loads such as sensors, lighting and displays, motors, actuators, fans etc. 156a-d, and user-accessible power receptacles like USB ports 166a. In some embodiments, LVDC load supply circuits are designed with metering 190a-d and power control circuitry 182a-d to allow for greater operational insight, power management, and energy management. The LVDC bus enables efficient power distribution and management for these low voltage devices, ensuring seamless integration and operation within the system.

The DCDC converter(s) 234 integrated within the system may be designed using isolated, non-isolated, resonant, boost, or boost-buck topologies, depending on the requirements of the power conversion process. These converters are critical for managing the different voltage levels and ensuring efficient power transfer between the DC sources, storage systems, and the DCAC. The power conversion circuitry in both the DCAC and DCDC converters utilizes advanced solid-state switching technology, with some embodiments incorporating Silicon Carbide (SIC) MOSFETs, IGBTs, or a combination of these components. These technologies are selected to achieve high efficiency, fast switching speeds, and robust thermal management, thereby helping to maintain the longevity and reliability of the system.

In certain embodiments, the system is further enhanced by incorporating advanced thermal management strategies, such as liquid cooling loops, convective heat sinks, or thermoelectric cooling, to maintain desired operating temperatures for both the power electronics and the battery modules. These thermal management systems are integrated to enable the system to operate efficiently under various environmental conditions, improving both performance and lifespan. The inclusion of such features not only supports high energy conversion and storage but also allows the system to be used in more demanding applications, such as grid stabilization, peak shaving, and emergency backup power.

In some embodiments, the design includes additional components for electrical safety, such as overcurrent protection devices (OCPDs) 134a-d that feature monitoring capabilities and are either resettable or replaceable. These safety measures are implemented to safeguard the system from electrical faults, ensuring reliable operation and protecting both the equipment and users from potential hazards. The integration of these safety features enhances the overall resilience and durability of the system by preventing damage due to overcurrent conditions and allowing for easy maintenance or restoration of protection functionality.

### Thermal System Architecture Overview

Electrical demand from loads within the internal thermal system (e.g. compressors, fans, blowers, pumps controlled valves, sensors, resistive heating elements, humidifiers/dehumidifiers, solenoids, thermostats, electronic controllers, electric motors, actuators, pressure switches, etc.) are supplied by one or a combination of connected sources: solar PV, internal battery energy storage, and/or AC supply input from building, as determined by the system's programmable logic to meet aligned objectives of the nanogrid's TMS, EMS, and AMS software systems.

For high system energy efficiency, the thermal system can have an integrated design to manage heating and/or cooling needs of the power system (i.e. power conversion and battery modules) along with the integrated loads (e.g. refrigeration, cooling, heating, and fluid movement systems). At a high level, the thermal system is designed to achieve the goals of cooling or heating one or more target internal component(s)/module(s) (e.g. battery modules, power electronics modules, condenser coils) and/or a target fluid volume inside of or proximate to this system. This can be achieved using a combination of passive and active thermal management methods, including convective heat sinks, radiation surfaces, and/or thermal conduction pathways to the ambient environment, and/or compressor-based refrigeration cycles, phase change materials, liquid cooling loops, thermoelectric coolers, and controlled airflow systems.

In some embodiments, the nanogrid's internal thermal load architecture is partially designed to provide refrigeration (i.e., cool the air volume of) one or more refrigeration compartments while simultaneously expelling waste heat to the ambient environment. In doing so, the system achieves refrigeration and/or freezing of food and beverages to preserve freshness and/or medicine at a controlled temperature. In some embodiments, the same thermal system is designed to periodically and automatically defrost one or more refrigeration compartments. In some embodiments, the same thermal system is designed to provide one or all chilled, hot, and/or boiling potable water tap(s). In some embodiments, the same thermal system is designed to make ice cubes using a chilling system and heating grid. In certain designs, the system may employ two or more compressors to independently manage different cooling zones within the appliance, such as separate refrigeration and freezer compartments. This multi-compressor setup enhances energy efficiency by allowing each compressor to operate only when its specific compartment requires cooling, providing better temperature control, reducing wear on the compressors, and increasing the overall longevity of the system.

In some embodiments, the nanogrid's internal thermal load architecture is partially designed to provide space conditioning by regulating the temperature and humidity of an interior environment, such as a room or building. This can be achieved by using a combination of active methods like compressor-based heating, ventilation, and air conditioning (HVAC) systems, heat pumps, and dehumidifiers, alongside passive strategies such as thermal insulation, radiant barriers, and strategically placed thermal mass. The system may also include air filtration and ventilation components to improve indoor air quality while maintaining desired temperature settings for comfort and energy efficiency.

In some embodiments, the nanogrid's internal thermal load architecture is partially designed to provide domestic hot water by heating water to a target temperature and distributing it through plumbing systems to various fixtures such as sinks, showers, and appliances. This can be achieved using methods including electric resistance heaters and/or heat pump water heaters. The system may also incorporate insulation for hot water storage tanks and pipes to minimize heat loss, as well as mixing valves to provide safe delivery temperatures.

In some embodiments, the nanogrid's internal thermal load architecture is partially designed to provide heat for washing and/or drying garments by heating water for washing cycles and air for drying cycles. This can be achieved through electric resistance heating elements and/or a heat pump system. The system may also include moisture sensors, energy recovery features, and advanced insulation to optimize energy use and improve garment care during the washing and drying processes.

In some embodiments, the nanogrid's internal thermal architecture is designed as an integrated system that not only manages the heating and cooling needs of various appliance/load functions but also optimizes the performance of the integrated battery energy storage components and power conversion system using a combination of active and passive thermal design. In some embodiments, this can be achieved via forced airflow from a stirring fan. In certain embodiments with a refrigeration loop (e.g. for refrigeration, for space conditioning, or where a heat pump system is present) the system is designed to provide cooling or pre-heating of battery components to enable them to operate within their ideal temperature range, thereby enhancing power performance and extending operational lifetime. Additionally, this method can cool power electronics, improving efficiency and maintaining operational temperature limits. The thermal system supports various appliance functions, such as refrigeration, space conditioning, and water heating, by efficiently redistributing waste heat or utilizing pre-cooled refrigerants. For example, waste heat from power conversion can be redirected to assist in water heating or defrosting processes, while a stirring fan that draws heat away from condenser coils can also help manage the temperature of battery modules. This integrated approach enables the thermal and power systems to work seamlessly together, enhancing energy efficiency, prolonging component lifespan, and allowing for improved integration with the appliance's load and functional requirements.

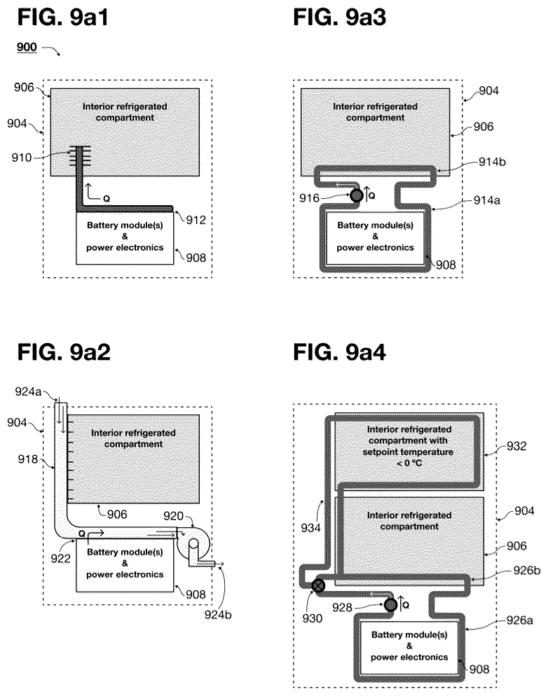

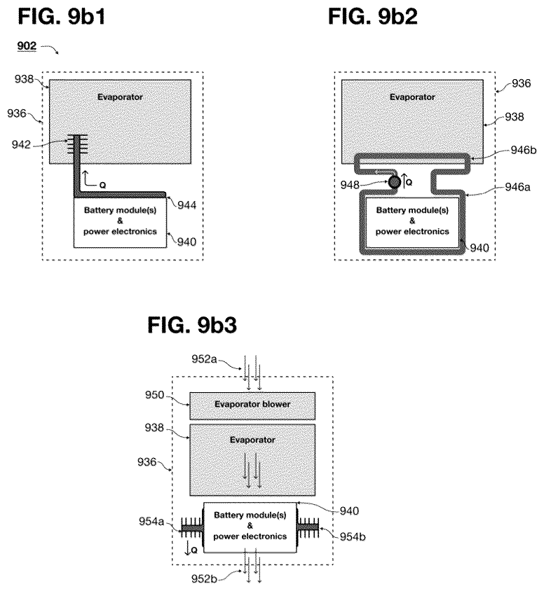

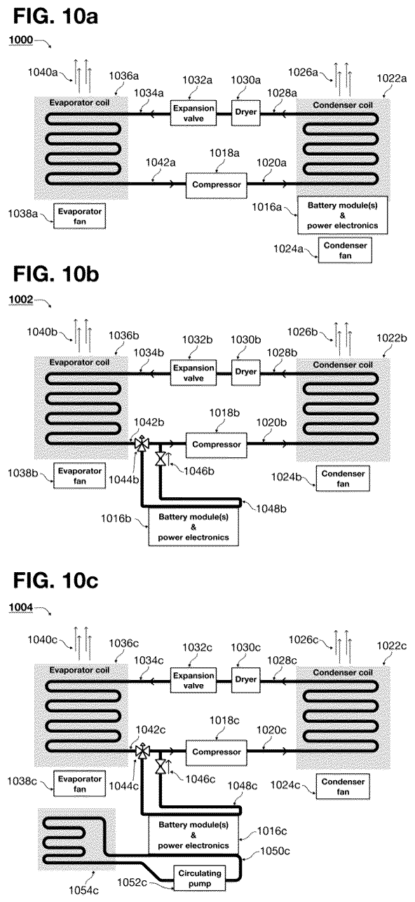

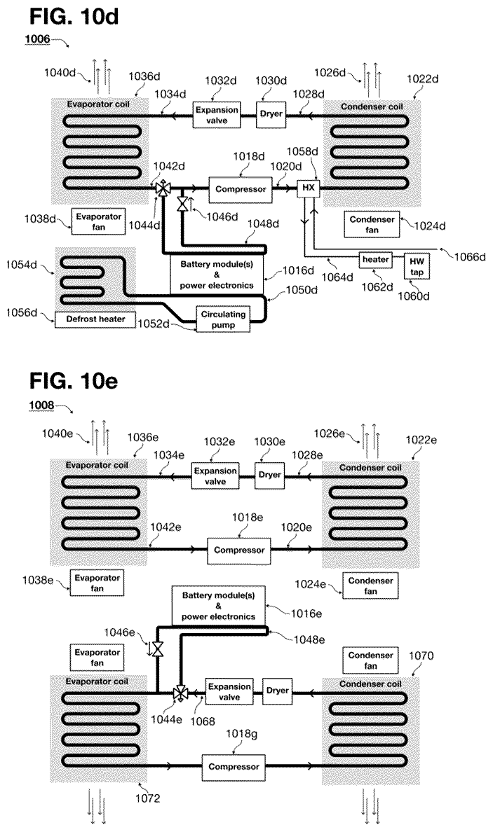

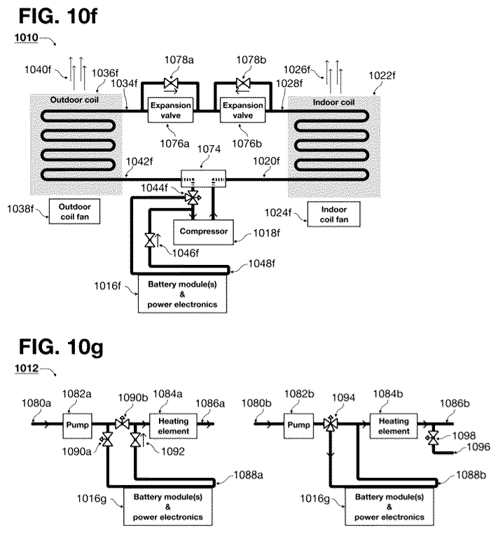

In some embodiments, methods for cooling battery and/or power electronics modules are realized via indirect interaction with a refrigeration loop system (i.e. the thermal load system) via one of or a combination of active or passive convective and conductive heat transfer strategies as illustrated in FIGS. 9a1-9a4 and 9b1-9b3. When the nanogrid system includes one or more refrigerated compartments 900 (e.g. as with a refrigerator or refrigerator/freezer) within the shared mechanical enclosure 904, the battery and power electronics module(s) 908 may be designed with a heat sink (e.g. constructed from Aluminum, Copper, or other effective thermally conductive solid material(s)) 910 which forms an effective thermal bridge 912 to the battery and power electronics module(s) to allow heat (“Q”) to flow conductively into the refrigerated air volume. In some embodiments to allow for greater control overheat flow, active strategies are employed. In some embodiments, a closed-loop fluid line 914a-b (e.g. containing water or other coolant mixture) with circulating pump 916 is designed to exchange heat with 914a the battery and power electronics module(s) 908 and then be carried via the loop 914b to the interior refrigerated compartment 906 for cooling before being returned to the battery and power electronic module(s). In other embodiments, an open-loop heat exchange system is employed to use a fan or blower 920 to draw ambient air 924a into a duct system 918 within the enclosure 904 and thermally coupled to the interior refrigerated compartment and/or evaporator coil(s) to pre-cool air before reaching the battery and power electronics module(s) 908 and exchanging heat 922 and then being exhausted back to ambient 924b. In some embodiments where the system 904 includes a freezer compartment (i.e. a refrigeration compartment cooled at or below zero degrees Celsius) 932, a closed-loop fluid line (e.g. containing water or other coolant mixture) may be designed to allow for both cooling of the battery and power electronics module(s) 908 or heating of the freezer compartment 932 to provide a defrosting function while reducing energy usage by other heating components (e.g. resistive heating elements). This may be achieved by a valve 930 which selectively routes the output line of the circulating pump 928, fed by the loop 926a thermally coupled with the battery and power electronics module(s), to either a refrigerator compartment 906 or via a secondary loop 934 to the freezer compartment 932 where the loop has effective thermal coupling to the interior walls of that compartment to melt accumulated ice. When the nanogrid system includes an evaporator coil designed with a blower, fan, or pump for cooling air or water (e.g. as with an air conditioning, HVAC, or heat pump system) 902 within a shared mechanical enclosure 936, a heat sink 942 (e.g. constructed from aluminum, copper, or other effective thermally conductive solid material(s)) may be used to move heat generated at the battery and power electronics module(s) 940 via a thermal interface 944 through the heat sink to the evaporator coil 938 or cooled area around the evaporator coil. In some embodiments, heat may be transferred from the battery and power electronics module(s) via a closed-loop fluid line 946a (e.g. containing water or other coolant mixture) and circulating pump 948 to the evaporator coil 938 or cooled area around the evaporator coil. In other embodiments, cooling of the battery and power electronics module(s) may be achieved via airflow drawn in 952a from ambient by the evaporator blower 950, blown over the evaporator coil system 938 and chilled, and then blown over the battery and power electronics module(s) and associated heat sink(s) 954a-b before being vented to the proximate space 952b. In other embodiments illustrated in FIG. 10a, the battery and power electronic(s) modules 1016a may be actively cooled by air blown over 1026a the module by the condenser fan 1024a.

In some embodiments, a method for cooling battery and/or power electronics modules is via direct interaction with a refrigeration loop system (i.e. the thermal load system) via direct coupling with a closed refrigeration loop by routing part of the refrigerant loop to the battery module and/or power electronics (and/or a heat exchanger block thermally coupled to these modules). This method is illustrated according to several embodiments in FIGS. 10b-f: The refrigeration cycle operates using a reverse Rankine cycle (or reversed Carnot cycle) to move heat from one area to another, typically to cool a designated space. A refrigerant is circulated through a closed loop, undergoing phase changes as it moves through the system. The cycle begins at the compressor 1018b-f, where the refrigerant is compressed, raising its pressure and temperature in the “discharge line” 1020c. The high-pressure, high-temperature gas then flows through the condenser coil 1022b-f, where it releases heat to the surrounding environment 1026b-f and condenses into a high-pressure liquid in the “liquid line” 1028b. This liquid refrigerant passes through a dryer 1030b-f (to remove moisture and contaminants from the refrigerant, containing desiccants that absorb moisture and a filter that traps particles and debris) and an expansion valve 1032b-f, where its pressure drops, causing a significant temperature decrease. The low-pressure, low-temperature liquid 1034b-f then enters the evaporator coil 1036b-f, where it absorbs heat from the space being cooled 1040b-f and evaporates back into a gas (with optional aid in heat transfer by a evaporator fan 1038b-f). Finally, the refrigerant returns to the compressor via the “suction line” 1042b-f, and the cycle repeats. The system creates a high-pressure side (condenser) and a low-pressure side (evaporator), enabling the transfer of heat from one location to another. In some embodiments demonstrated by FIGS. 10b-d, the TMS may increase active cooling to the battery and power electronics module(s) 1016b-d by using a multi-way valve 1044b-d to route the cool refrigerant in the suction line through an auxiliary loop 1048b-d thermally coupled (e.g. via conductive solid blocks, thermal paste, and/or heat exchangers) to the target modules, before returning the refrigerant to the compressor. A one-way valve 1046b-d may be employed to prevent backflow when this auxiliary loop is bypassed. In some embodiments illustrated in FIGS. 10c-d, heat generated by the battery and power electronics module(s) 1016c-d may be routed to another location in the nanogrid system 1054c-d (e.g. a freezer compartment, to provide heat for periodic defrost cycles) via a secondary closed fluid loop 1050c-d (e.g. containing water or other coolant mixture) and circulating pump 1052c-d, controlled by the TMS. This secondary loop serves to simultaneously cool the battery and power electronics module(s) when circulating. In some embodiments illustrated in FIG. 10d, a supplementary electric heat may be included as a supplement or alternative to the secondary loop 1050c-d. In some embodiments illustrated in FIG. 10e, the nanogrid's thermal load system may employ two or more closed refrigerant loops (e.g. with a high-pressure side condenser 1022e, 1070 and a low-pressure side evaporator 1036e, 1072). In this design, the battery and power electronics module(s) 1016e may be directly coupled to one refrigerant loop via a controlled auxiliary bypass loop 1044e, 1046e, 1048e. This design allows for efficient use of additional compressor-based refrigerant loops with a lower duty cycle and/or lower heat transfer rate, such as would be designed for a refrigeration compartment with desired temperature above that of the other refrigeration loops. In some embodiments illustrated in FIG. 10f, the nanogrid system thermal load architecture may contain a heat pump (HP) system with reversing valve 1074 to allow for reconfiguring an indoor coil 1022f and indoor coil fan 1024f to provide either heating or cooling 1026f, with the outdoor coil 1036f and outdoor coil fan 1038f providing an opposite heating/cooling function 1040f. To enable this function, along with the reversing valve, an additional expansion valve 1076b and one-way bypass valves 1078a-b at each expansion valve is included in the design. In such designs 1010, a similar heat exchange strategy with the battery and power electronics module(s) 1016f can be achieved by designing the rerouting valve 1044f, auxiliary bypass loop 1048f, and one-way backflow prevention valve 1046f so that they connect after the reversing valve and before the compressor 1018f input (i.e. the low-pressure side).

In other embodiments where the nanogrid thermal system includes open-loop supply from domestic water (e.g. for water heating, dish washing, or clothes washing) illustrated in FIG. 10g, this water loop may be used for heat exchange with other elements of the nanogrid system. In this design, domestic water supply 1080a-b connected to the nanogrid system pressurized by an optional water pump 1082a-b may be directed through an auxiliary loop 1088a-b in thermal contact with battery and power electronics module(s) 1016g via one or more valves 1090a-b, 1094 controlled by the TMS along with optional backflow-prevention valve(s) 1092. This auxiliary loop serves to provide cooling to the battery and power electronics while simultaneously preheating feed water prior to an in-line heating element 1084a-b, such as a resistive heater or heat pump coil, before being sent to the building water supply or being used by the nanogrid system 1086a-b or routed to a drainage line 1096 via an overflow or drain line valve 1098.

As described above, the nanogrid system's electrical loads may be designed to operate on either AC or DC power, depending on the application and design goals. Compressors and fans, which are critical for cooling and air circulation, can be either AC or DC. In some embodiments, the system's compressors, fans, pumps, heaters, actuators, sensors, etc. are designed to be powered by DC to allow direct supply from the common DC bus i.e. via the battery or solar PV system of the nanogrid, or through AC from the premises supply connection, which is converted to DC by the DCAC converter. This setup enhances the system's adaptability to different power sources and improves energy efficiency. In some embodiments, the system may incorporate variable speed DC compressors and motors, enabling more efficient and granular temperature control, which can lead to significant energy savings and improved performance. This flexibility in power source and control options allows the thermal system to seamlessly integrate with the nanogrid, enhancing both its efficiency and applicability in different settings. To confer more flexibility, in some embodiments resistance heaters within the system may be configured to run on both AC or DC, offering flexibility in design and the ability to tailor the system to specific power supply scenarios, for example, using AC when the present from the premises wiring system to reduce AC-to-DC conversion losses from these heating loads.

In various embodiments, the system may be designed to utilize different refrigerants tailored to specific performance and environmental criteria. The selection of refrigerants within this system is carefully engineered to balance thermodynamic efficiency, safety, material compatibility, and environmental impact. For instance, the system may employ refrigerants such as hydrofluorocarbons (HFCs), including but not limited to R-134a and R-410A, which offer effective cooling properties while adhering to lower global warming potential (GWP) requirements in certain applications. In alternative embodiments, the system may incorporate natural refrigerants, such as propane (R-290) or ammonia (R-717), which are characterized by minimal or zero GWP, thereby aligning with stringent environmental regulations aimed at reducing contributions to climate change. The system is further adaptable to accommodate advancements in refrigerant technology, allowing for the integration of next-generation refrigerants as they become available. This flexibility enables the system to maintain high performance and reliability while minimizing its environmental footprint across various applications. Additionally, the design considers safety aspects related to refrigerant use, such as flammability and toxicity, ensuring that the refrigerants are compatible with system materials and comply with relevant safety standards. By offering the capability to use a range of refrigerants, the system is positioned to meet diverse operational needs while supporting global efforts to mitigate environmental impacts associated with refrigeration and heat pump technologies.

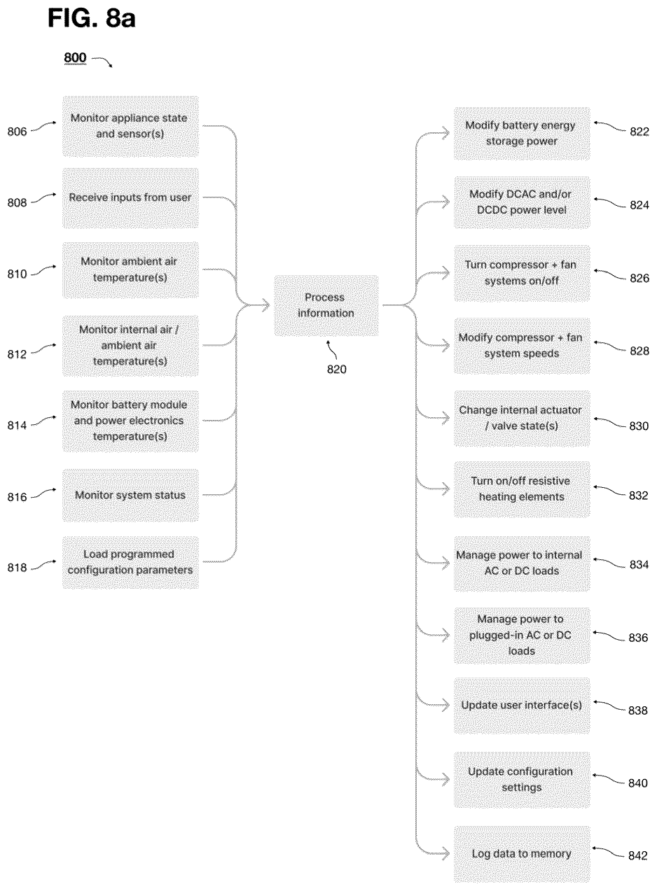

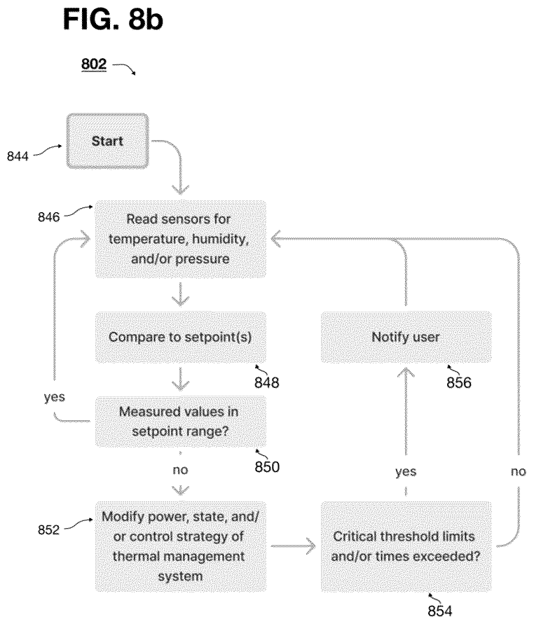

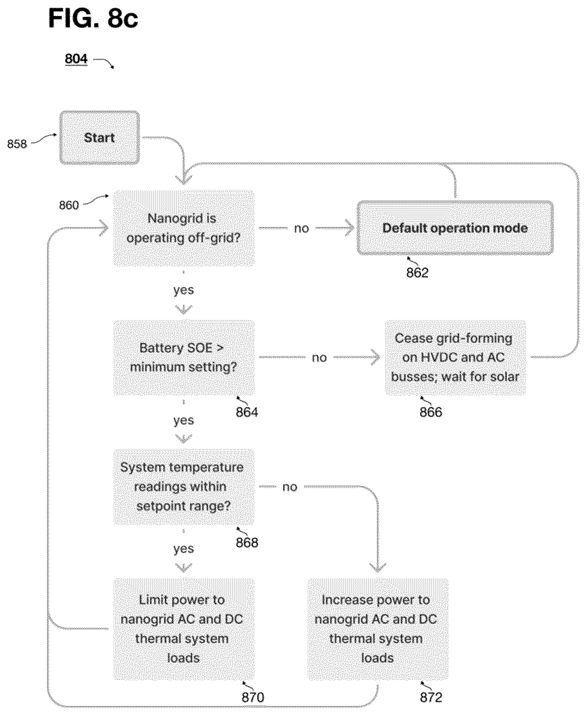

The nanogrid system leverages advanced sensing technologies integrated into its TMS 800, shown in an embodiment in FIG. 8a, and AMS, to provide desired performance, safety, and efficiency. The TMS utilizes temperature, pressure, and flow rate sensors strategically placed throughout the refrigeration loop and other thermal system components to monitor and control the operation of thermal loads like the compressor (e.g. duty cycle and/or speed), ensuring it operates safely and efficiently. These critical signals are continuously fed into the TMS and AMS software via the nanogrid system's control circuitry, allowing for real-time data processing and responsive control.

The TMS is designed to collect a variety of input data, such as by monitoring the appliance state and appliance-connected sensors 806, monitoring ambient air temperature via integrated temperature sensors 810, monitoring air temperature internal to the nanogrid device/appliance at one or more locations 812, and/or monitoring temperature internal to the nanogrid device's battery module and power electronics components (e.g. the DCAC converter) at one or more locations 814. Additionally, the nanogrid system may receive inputs to the TMS via user-provided input 808, via system status monitoring 816, and/or via loading programmed configuration parameters from memory 818. Input data are received and processed 820 by the embedded processor module(s) 206. Once processed, the nanogrid system may take actions to modify power, such as by varying charge/discharge power of the onboard storage battery 822, modifying input/output power or power factor of the DCAC converter 824, managing power to internal loads 834, and/or managing power to external plugged-in loads 836 when applicable. When applicable, the nanogrid system may also take action to modify power to internal loads, such as by turning on or off compressor and fan system(s) 826, modifying the speed of compressor and fan system(s) 828, changing the state of internal actuators or valves within the thermal system 830, and/or turning on or off resistive heating elements within the thermal system 832. Additionally, after processing energy and power data and settings, the system may be updated configuration settings 840, log data to memory 842, and/or update user interfaces 836 including displays, status LEDs, and/or externally accessible API(s).

FIG. 8b shows an example of processing logic 802 that can be employed by the TMS for purposes of maintaining the system's software-defined thermal and operational setpoints and limits. Once this software logic initializes 844, data is collected from integrated sensors to measure temperature, humidity, and/or pressure at one or more locations within the system 846, and the readings are compared to setpoint(s) 848. The processor then determines if these measured values are within range 850, and if they are continuous measurement continues. If they are not in range, the nanogrid system takes action to modify power, state, and/or control strategy of the TMS 852. At this point, the system also evaluates if any critical threshold limits or times are exceeded 854, and if this is determined to be true, the system issues a notification to the user 856 such as via onboard user interface and/or dashboard such as a smartphone app via the onboard wireless connections maintained by the system. In this way, users are made aware of any performance issues that may affect the systems performance or safety.

Similarly, FIG. 8c shows an example of processing logic 804 that can be employed by the TMS related to off-grid, intentional islanding operational modes wherein the thermal system and its setpoints and energy usage may be modified based on energy source(s) and storage to provide reliable operation throughout power outages. Once this software module initializes 858, the system ascertains whether the nanogrid is in an off-grid (i.e. intentionally islanded) state 860, and if not, the system proceeds to a default operation mode 862. If the system is operating off-grid, the system considers whether the battery state of energy (SOE) is above a defined minimum setting 864, and if this condition is false, indicating insufficient energy reserve to provide backup power to loads associated with the nanogrid, the nanogrid system ceases grid-forming on the high voltage DC (HVDC) bus and AC bus 866 until a source is made available for charging the battery, such as voltage at the DC solar input. Conversely, if the minimum SOE check passes, the system evaluates if systems temperatures are within a defined setpoint range 868. In order to efficiently utilize stored energy while off-grid, the system is designed to limit power to the nanogrid's AC and DC thermal system loads 870 when setpoints are within the defined off-grid range, and conversely increase power to these loads 872 if setpoints are not within this defined range.

Temperature sensing methods within the system may include thermistors, RTDs, or thermocouples, located at key points such as the evaporator, condenser, and compressor, as well as within the refrigeration compartments and ambient environment. This data allows the AMS to implement precise control strategies to maintain setpoints and adjust system behavior based on user preferences and ambient conditions, including seasonal variations and predicted environmental changes.

The AMS uses this sensor data to manage appliance operation, dynamically adjusting settings to meet user-defined preferences while optimizing energy usage as illustrated in FIG. 8a. Meanwhile, the TMS also employs these sensors to manage the thermal state of the nanogrid's battery and power electronics, adjusting cooling or heating control strategies described above as necessary to maintain desired operating temperatures and prolong system lifespan. These sophisticated control methods enable both the nanogrid and connected appliances to operate efficiently, safely, and in alignment with user needs and environmental conditions.

### Compute, Software, and Communication System

A nanogrid system in at least some embodiments includes a powerful onboard compute system to enable the intelligent set of system behaviors including but not limited to: controlled cooling, controlled heating, mechanical movement, controlled fluid flow, energy monitoring, energy optimization, energy and power management, thermal optimization, battery charge/discharge optimization, solar power optimization, software-enabled safety functions, data logging and storage, system performance monitoring, management of one or more wireless network connections, internet connectivity, telemetry, interoperability with other software-enabled systems on-premises, performing over-the-air (OTA) software updates, user interface display. The compute system is designed to support flexible, programmable behaviors via software programming and storage of software routines.

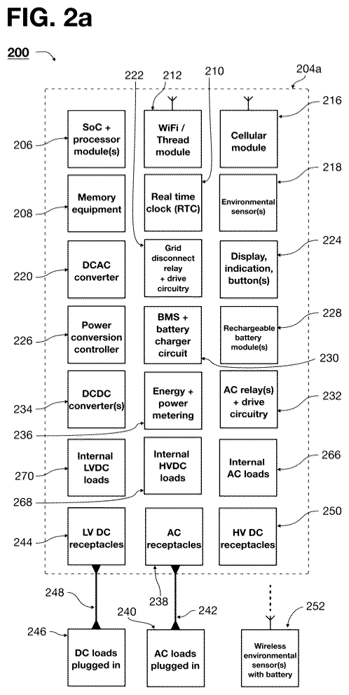

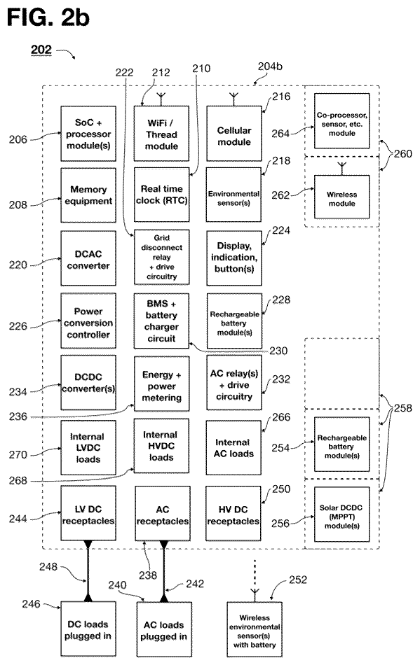

An example of the on-board compute system is shown in FIG. 2a. The onboard compute system 200 exists on one or more printed circuit board assemblies (PCBAs) enclosed within the system's housing and includes one or more integrated circuits (ICs), application specific integrated circuits (ASICs), local memory storage 208, a real-time clock 210, and supporting electrical componentry. In some embodiments, the compute system design leverages a programmable Linux-capable system-on-chip (SoC) in conjunction with one or more programmable co-processors 206 running real-time operating systems (RTOS). Data collection for use by the system's software is facilitated by an array of environmental sensors 218 including temperature, humidity, position, air quality, and more. Data collection specific to energy and power data is facilitated by energy metering circuitry 236 including current sensors, voltage dividers, and power metering ASICs. The system's SoC(s), IC(s), ASIC(s), memory units, communication modules, and processors are designed to exchange data with one another (i.e. communicate using software) via one or more of the following methods: SPI, I2C, USB, RS485, RS232, CAN bus, Ethernet, and other serial protocols.

To provide connection to the Internet, connection to back-end (i.e. Cloud) software systems 306, connection to client web and smartphone applications 318, and/or connection to other TCP/IP based software systems on-premises (e.g. over the local area network, LAN), the system includes one or more wireless modules including radio transmitter and receiver modules and wireless antenna. In some embodiments, the system includes a Wi-Fi radio 212 (i.e. IEEE 802.11) capable of wireless communication 308 via 2.4 or 2.4 and 5 GHz networks to a local area network (LAN) router(s) 310 within the premises. To reduce reliance on consumer internet systems and provide higher reliability internet connectivity, some embodiments of the system integrate Cellular module (e.g. CAT NB-IoT, CAT M, LTE) 216 which maintains connection 312 to the Internet via a local cellular communication network 314. The system is designed to support dynamic evaluation and routing between one or more available Internet connection routes 316, 328. The nanogrid system 302 is designed to leverage wireless communication to maintain a connection to 330 and exchange data with one or more other on-premises nanogrid systems 304.

The nanogrid system's robust and flexible software and communication architecture 300 allows for extensive interoperability with both Cloud and on-premises software systems. The nanogrid system(s) are designed to exchange data with other 3rd-party on-premises software systems 318 (such as via the LAN 326) related to energy management and occupant experience, including Home Energy Management Systems (HEMS), Building Management Systems, solar PV systems, premises-level MCS, premises-level PCS, and Human Machine Interfaces (HMI) such as voice assistants or dashboard systems. In some embodiments, the system is capable of direct connection to client applications 318 by providing a direct connection to one or more nanogrid systems, such as via a Wi-Fi access point (AP), Bluetooth connection, or Thread/Matter connection.

In some embodiments, a cellular module including global positioning system (GPS) functionality is used to infer the installed location of the device, allowing the system to infer location specific details about the local grid, such as grid code, grid voltage, grid frequency, grid operator details, and more.

In some embodiments, the system is designed to allow easy direct user-connection of external wireless modules 262 and/or compute modules 264 to extend the functionality of the system over time. This can be achieved with specially designed modular connections 260 providing both low voltage DC power and connection to a communication bus (e.g. USB) via a pluggable connector (e.g. USB type C). In some embodiments, similar expansion of capabilities can be achieved by wirelessly pairing sensor modules 252 which contain their own integrated power source, such as an onboard battery.

### Energy Management System (EMS) & Power Control System (PCS)

The integrated design of the nanogrid system-incorporating co-located loads, generation, and storage plus software-enabled logic to intelligently participate within a home/building's energy ecosystem and with the broader utility power grid-creates high granularity of power and energy management within the built environment. This control can be deployed to create utility bill savings, for example, by shifting consumption from the utility grid to times of lower pricing, by aligning load consumption with onsite solar generation, by storing onsite generation and dispatching that stored energy later, and/or by reducing apparent power demand at the building utility meter to reduce demand charges.

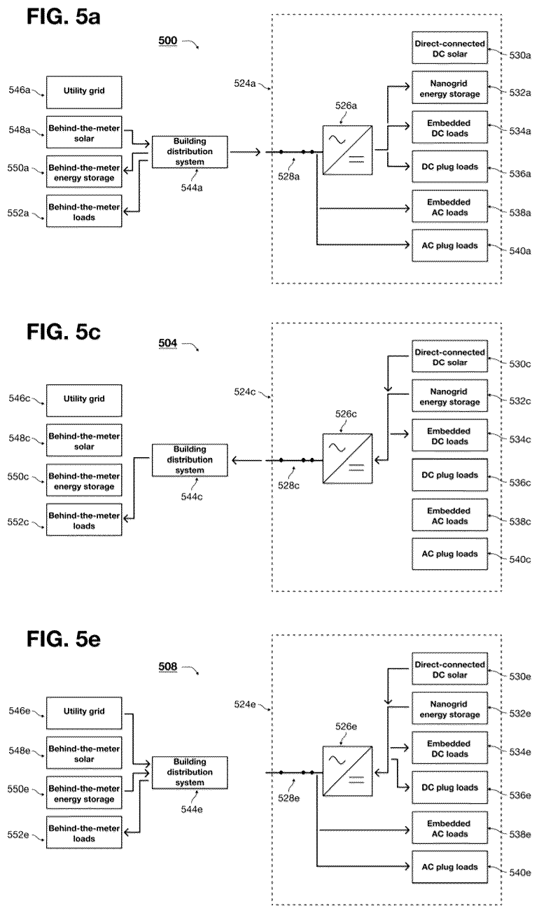

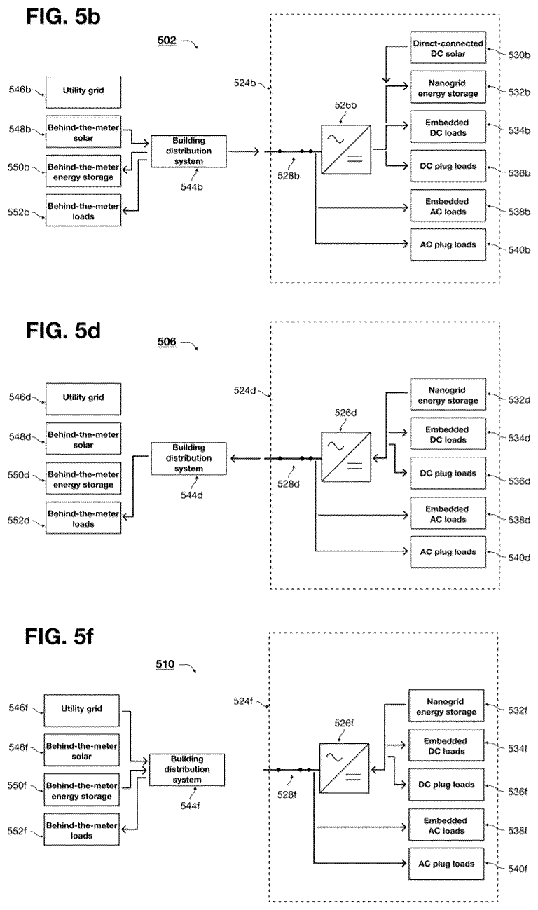

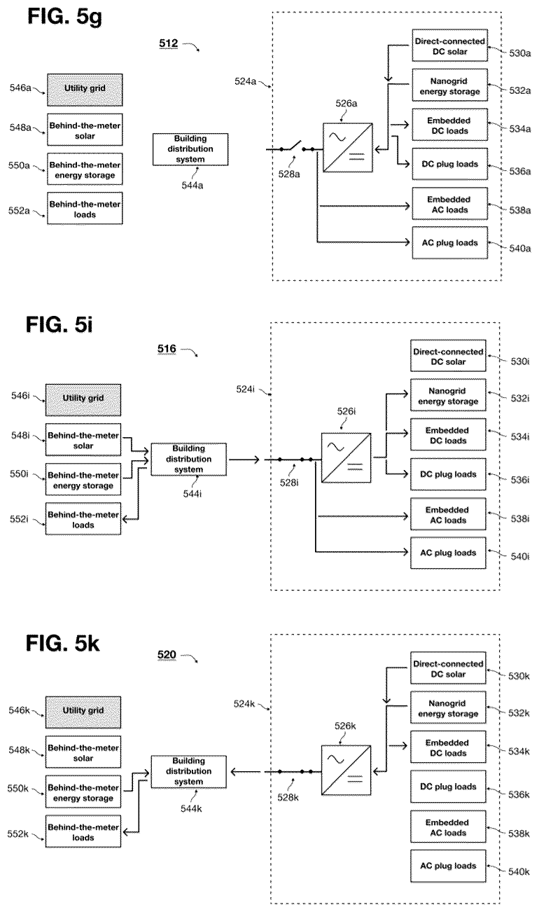

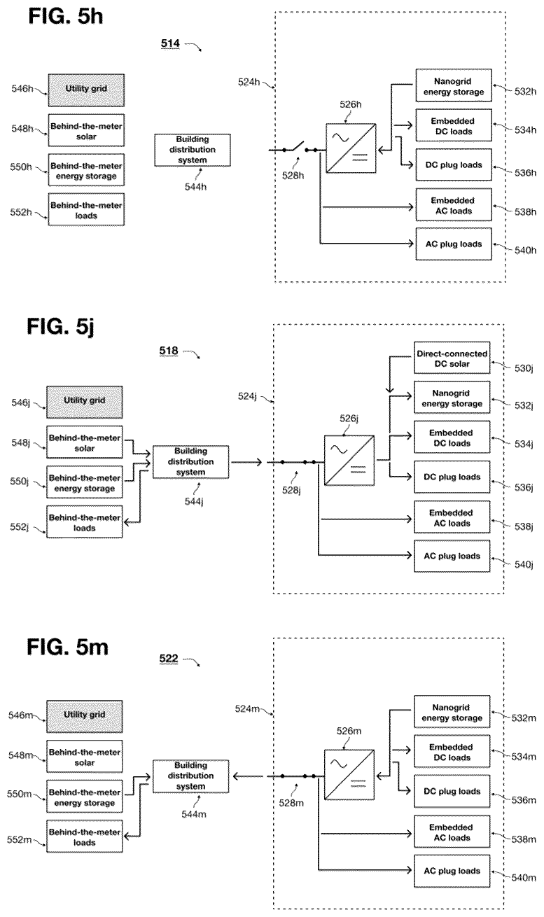

Management and optimization of energy usage, storage, and supply related to the nanogrid is controlled by the system's EMS, including programmable software and electrical circuitry to measure, calculate, and modulate power flow within the nanogrid system. The software-defined nature of the EMS provides an exceptional degree of flexibility and adaptability based on user goals, system constraints, and real-time conditions within the nanogrid system and within the premises, as shown by FIG. 5. When the nanogrid system 524a-m, (which includes onboard DCAC converter 526a-m, MID 528a-m, energy storage 532a-m, and one or more of: DC-connected solar 530a-m, embedded DC loads 534a-m, DC plug-connected loads 536a-m, embedded AC loads 538a-m or plug-connected AC loads 540a-m) is connected to the premises wiring system 544a-m (which may connect to one or more of: utility grid 546a-m, behind-the-meter loads 552a-m, behind-the-meter solar photovoltaic system(s) 548a-m or behind-the-meter energy storage system(s) 550a-m) the EMS may orchestrate the system 1202 to provide net power import 500-502, net power export 504-506, or no net export (i.e. no current flow) 508-510 to the building electrical system via the nanogrid's AC supply connection. When the nanogrid system is disconnected from the premises wiring system (i.e. when the nanogrid's MID is opened), the EMS manages power flow between loads, sources, and generation within and connected to the nanogrid system. When a premises-level microgrid is present (i.e. MID and generation/storage are present upstream of the nanogrid system), the nanogrid system is designed to ascertain the islanding state of this other microgrid system, and the nanogrid EMS may provide net power export 520-522 (e.g. to support onsite loads) or provide net power import 516-518 (e.g. to charge from excess building-level solar PV system generation) from the building.

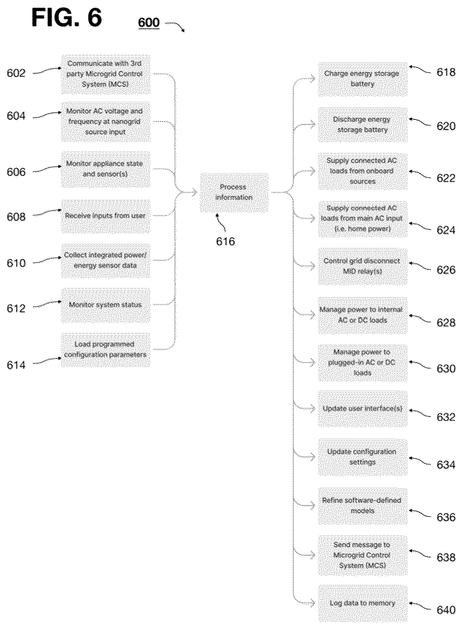

An example of software-defined interactions with a premises-level microgrid system, performed by a nanogrid system, are shown in FIG. 6. The system is designed to collect a variety of input data such as via software-defined communication with a 3rd-party Microgrid Control System 602 (such as a centralized battery energy storage system) to gather information about building-level islanding, energy, power, and status of other behind-the-meter Distributed Energy Resources (DERs) such as solar systems, as well as via measurements made by the nanogrid system such as: AC voltage and frequency proximate to the system 604, appliance state and appliance sensors 606, integrated energy and power sensors 610, system internal mode and operating status 612, inputs from users 608 made via onboard user interfaces or external platforms such as a smartphone application, and/or by loading programmed configuration parameters 614. Inputs data are received and processed 616 by the embedded processor module(s) 206. Once processed, the nanogrid system may take actions to modify power such as by varying power to the onboard storage battery to cause it to charge 618, varying power to the onboard storage battery to cause it to discharge 620, supplying power to connected AC loads from onboard energy sources like storage battery and/or solar 622, supplying power to connected AC loads from the main AC input 624, controlling the MID relay to intentionally island the nanogrid system 626, managing power to internal AC and/or DC loads 628 such as by actuating relays or electrical actuators or varying software-defined power transfer protocols (e.g. USB Power Delivery) 628, managing power to external plugged-in AC and/or DC loads 628 such as by actuating internal relays or electrical actuators or varying software-defined power transfer protocols (e.g. USB Power Delivery) 630, and/or by sending control messages to external MCSs (e.g. a centralized building energy storage system) 638. Additionally, after processing energy and power data and settings, the system may take further action to update configuration settings 634, log data to memory 640, refine software-defined models to inform system operation 636, and/or update user interfaces 632 including displays, status LEDs, and/or externally-accessible API(s).

PCS orchestration of one or more nanogrid systems in aggregate may be used to achieve a net power change (i.e. increase or decrease) across a defined point within the premises' electrical wiring system, notably at the Point of Interconnection to the utility power grid, at the location of conductors feeding a utility electric meter and service disconnect.

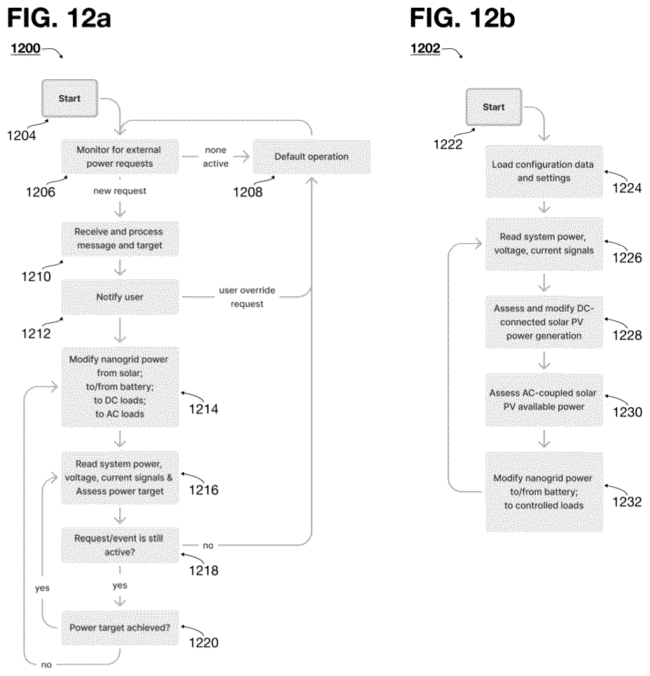

The intelligent, connected design of the nanogrid system also allows for participation with demand response (DR) and virtual power plant (VPP) systems where DERs receive commands to modulate their power (net consumption or generation) as illustrated in FIG. 12a. In process 1200, the nanogrid system is capable of receiving such a command via one of its internet connection routes, processing the message, storing the message, adjusting performance to achieve the command, measuring result, and confirming actions and measurements with the originator system. To achieve this functionality, the software service is initiated 1204 and continuously monitors for external power requests 1206. If no active requests are received, the EMS proceeds with default operation 1208 determined by the nanogrid systems own internal settings and operational logic. Conversely, when a new external request is received (e.g. via a software API connection, locally or via a cloud-connected server system), the EMS processes the message and extracts the requested target value (e.g., for power, power factor, current, battery state of energy, etc.) 1210, and may notify the user to provide the user the ability to opt out of external control 1212. If there is no user override action, the EMS system takes action to modify power flow(s) within the nanogrid system such as by increasing or decreasing power from connected solar PV, from battery charge/discharge, to connected and integrated AC and/or DC loads 1214 with the goal of achieving the received target. During this time, the EMS continually reads system power, voltage, current at one or more points to calculate performance against the last received external power target 1216, as well as continually assessing whether the request or event is still active 1218. If the request or event has elapsed or timed out, the system returns to default operation as described above, and if conversely the request/event is active, the EMS calculates if the power target has been achieved 1220 and continually makes power modifications to achieve the target, while respecting internal safety and performance constraints defined by the BMS, TMS, PCS, DCAC, and other internal systems.

The EMS is designed to support flexible charging from onsite solar power, either DC-coupled (e.g. connected to one of the nanogrid system's DC buses) or AC-coupled (e.g. via the building's AC electrical distribution wiring). When the EMS is configured to selectively prioritize onsite solar generation, the EMS initializes a process 1202 for solar utilization 1222 which causes the software system to load configuration data and settings 1224 related to power limits, battery state of charge, user preferences, utility tariff information, information about onsite solar generation, etc. The EMS then reads system power, voltage, and current signals at one or more points within the nanogrid system 1226 and first assess and modifies DC-coupled solar PV power generation 1228 before proceeding to assess available AC-coupled solar PV power 1230. Based on the latest data about solar production onsite, the EMS logic causes the nanogrid system to modify power to/from the integrated battery system and/or to controlled loads connected to or integrated within the nanogrid system 1232, while continually assessing changing power information 1226-1232.

### Microgrid Control System (MCS)

The nanogrid system is designed to seamlessly supply backup power to integrated loads during grid outages as well as to provide protection against anomalies on the connected AC supply such as sustained overvoltage or undervoltage conditions, which could jeopardize performance and longevity of the system. This process of disconnection from the primary AC supply (i.e. the building's distribution wiring) to provide dedicated voltage-forming to connected loads is called “intentional islanding.” An example of a process 400 of performing intentional islanding is illustrated in FIG. 4. The nanogrid system continuously monitors the grid's AC voltage and frequency at its AC power input 404 (i.e. at the electrical connection to the premises wiring 120-22), ensuring an autonomous and prompt response to such disturbances.

Grid disconnection and reconnection are managed through software-controlled logic—the MCS—allowing for adjustable timing and sensitivity to disturbances. In the event of a grid anomaly or outage, the system considers whether the nanogrid system is ready to grid form 408, and if so, employs an onboard grid disconnect relay (MID) to safely isolate itself 410 and all connected devices from the grid or microgrid before transitioning to an intentional islanding mode 412. This isolation can be achieved by disconnecting the current-carrying AC power conductors at the system's AC input, with the capability to disconnect phase conductors or both phase and neutral conductors simultaneously, depending on regional requirements.

Once disconnected from the grid, the system automatically switches to a grid-forming (voltage-forming) mode, providing continuous backup power to both internal AC loads and AC output receptacles while also maintaining power on the internal HVAC and LVDC busses to supply internal DC loads, allow battery charge/discharge, allow injection of solar power when present, and supply DC outputs for charging portable plugged-in devices.

The software-defined EMS actively manages power distribution during backup, limiting consumption to preserve battery life and ensuring total power draw stays within defined limits. Integrated software-controllable AC and DC power relays enable selective control over power delivery to specific internal loads and/or receptacles. To prevent over-discharge or damage, the system will automatically cease power output and shut down non-essential peripherals when the onboard battery reaches a critical low state of energy, or if the battery cannot support the instantaneous demand of connected loads.

When grid voltage returns 414, or returns within defined acceptable bounds, the system carefully monitors and qualifies the voltage and frequency conditions 416 before synchronizing to grid voltage, frequency, and phase angle 418 to seamlessly reconnect by closing the grid disconnect relay 420 and returning to a grid-following mode 402. Seamless reconnection is enabled by including line-side and load-side voltage monitoring across each leg of the MID relay in the design.

To ensure sufficient battery energy is always available for backup, users can set a reserve level of battery State of Energy (SOE), dedicating a predetermined percentage of battery capacity specifically for backup purposes. The system's onboard intelligence also provides outage alerts to users via indicators and companion smartphone and web applications, combining advanced hardware and software capabilities to deliver reliable and user-friendly backup power functionality.

### Appliance Management System (AMS)

The system's AMS functions as an advanced monitoring and control system, continuously gathering and analyzing data on aspects of the nanogrid system's performance to provide users with actionable insights and enhance appliance performance. By leveraging onboard computation and a variety of internal sensors, the AMS collects and processes appliance metadata, power and energy measurements, and environmental data to achieve a range of objectives aimed at optimizing appliance operation and extending the lifespan of internal loads, sources, storage, and electrical and mechanical components. The AMS can be implemented at least partially as software.

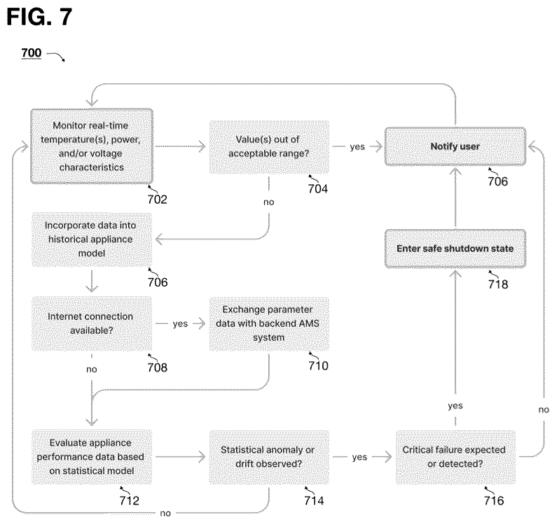

The AMS can include one or more algorithms for early failure prediction, an example of which is illustrated in FIG. 7, which may utilize Machine Learning (ML) models and statistical analysis techniques to continuously evaluate the health 700 of the systems internal AC and DC loads. By analyzing real-time and historical data, these algorithms can identify patterns that may indicate potential failures, allowing the system to alert users to risks before any significant malfunction occurs. This proactive approach to maintenance helps prevent costly repairs and extends the life of appliances. The AMS implements preventative maintenance strategies by developing dynamic models that set operational limits and heuristics for the internal nanogrid loads. It continuously monitors key parameters 702, such as current draw during various states (startup, run, shutdown, idle), and executes periodic test routines to assess appliance health. Collected data are analyzed to determine if any values are out of range 704, and if so, the user will be notified 706 such as by onboard user interface or via monitoring dashboard system(s) or smartphone application(s). Over time, the AMS refines its software models 706, potentially receiving updates and inputs from cloud services 710 when internet connectivity is available 708. The system uses these statistical models to continually evaluate appliance performance 712, and to detect statistical anomalies and/or drift in key parameters 714. If critical issues are predicted by the model 716, the system is designed to enter a safe shutdown state 718 to minimize harm to equipment, persons, or property and users are notified 706. This evolving model adapts to seasonal changes, ambient temperature variations, and user interactions, enabling the AMS to provide real-time status reporting and early warnings for potential maintenance needs, ultimately enhancing appliance longevity and performance. In some embodiments, these AMS software models are stored and processed entirely on the nanogrid's local compute system, while in other embodiments some processing is carried out in backend Cloud systems with periodic parameter syncing with the nanogrid's local compute system.

In addition to failure prediction, the AMS employs real-time environmental sensing and power data to deliver features aimed at mitigating issues due to use, such as leaving doors open or entering erroneous settings. These functionalities are particularly valuable for refrigeration appliances, ensuring users are immediately informed of conditions that could compromise appliance performance or food safety. Notifications can be delivered through visual or auditory alerts on the system, as well as via mobile text messages, email, or companion smartphone and web applications.

In some embodiments, the AMS regularly collects and integrates data from internal refrigeration loads, including temperature and humidity levels within compartments, door state(s), compressor speed and power draw, fan states and current draw, louver and solenoid states, operational status of internal components like ice maker(s) and defrost heater(s), as well lifetime runtime of aforementioned components. This data allows for precise monitoring and control, ensuring high performance, maintenance, and energy efficiency.

For integrated HVAC loads, the AMS may gather data on air temperature and humidity, fan speed, compressor activity, and power consumption, as well as the status of components like heating elements or valves. This comprehensive data collection supports real-time adjustments, early detection of potential issues, and tailored control strategies to maximize comfort and efficiency.

The AMS software can work in tandem with the system's EMS to further optimize energy usage across the nanogrid. By integrating data on power sources, internal and connected loads, and user preferences, the EMS can manage the distribution of energy to reduce costs and environmental impact. For example, a “Clean Power Mode” feature can allow the system to prioritize the use of onsite solar energy-whether AC-coupled or directly DC-connected-thereby minimizing reliance on grid power and lowering the carbon footprint of appliances without compromising key performance aspects of the internal loads.

The AMS also supports additional functionalities such as preventative maintenance alerting, seasonal energy adjustments, and the ability to remember and learn user preferences (e.g., temperature settings, operation modes). These features contribute to a more intelligent, user-friendly system that not only enhances appliance performance but also aligns with energy efficiency and sustainability goals.

### User Interfaces

The nanogrid system can be designed with a comprehensive user interface (UI) 224 including display(s), status indicator(s), and button(s) that provides real-time visibility into the state of the system and connected appliances, enabling users to manage and interact with the system effectively. The system's UI can provide system status and information, interfaces for user interaction and control, and interfaces for controlling the connecting of loads and managing of connected loads. The system's UI includes (1) on-device visual and auditory signaling, (2) communication and control via an associated smartphone and web application (Mobile and Desktop/Web Apps), (3) via secure APIs for easy device-to-device interaction with other software systems.

The UI can provide detailed insights into the nanogrid system's current operational status, including the state of charge of the battery, grid status, outage conditions, and backup time remaining. It can also display significant appliance information, such as temperature, setpoints, runtime, energy usage, active or historical faults, and the state of components like doors or compressors. This information can be presented clearly to allow users to monitor the performance and health of their appliances and the overall nanogrid system.

In some embodiments, the system includes an onboard screen for displaying detailed information and settings, accompanied by LED status indicators that provide at-a-glance updates on system health and operation. Visual and auditory signals alert users to important changes or conditions, such as power outages or fault detections, ensuring that users remain informed and can respond promptly to any issues.

Users can interact with the system through various input methods, including an onboard screen, LED status indicators, and a companion smartphone app. The interface supports setup flows and settings management, allowing users to configure connectivity, operational modes, and personalization options. Users can also clear faults, for example GFCI trips or software errors, through the UI. The design can enable users to control power output to different receptacles, whether to charge devices like smartphones during a power outage or to manage energy consumption based on solar generation or other considerations.

AC and DC receptacles can be strategically placed for user convenience, which may be on the front, side, or back of the system's enclosure. This placement supports easy access for users when connecting devices or appliances, while also allowing for hidden cord management for fixed appliances (e.g. in a kitchen scenario: microwave, food disposal, dishwasher, wine fridge, etc.). In some designs, receptacles may be located behind a toolless cover to enhance aesthetic appeal and provide mechanical and environmental protection.

Because of this user-centric design, the nanogrid system is not only functional but also intuitive and adaptable, meeting the diverse needs of users while maintaining ease of use and operational efficiency.

### Subsystem Modularity

The nanogrid system is designed with a high degree of modularity, enabling users to upgrade, modify, and maintain the system's capabilities over time. This approach enhances the system's longevity, sustainability, and adaptability to changing user needs and technological advancements.

Upgradability and End-of-Life (EOL) Considerations: Modular design facilitates easy upgrades, allowing users to enhance system performance or add new features as they become available. For example, additional battery modules can be connected to increase backup duration or to provide portable power around the home, such as during power outages. This modularity also supports better end-of-life management; components like batteries and refrigerants can be more easily recovered, recycled, or replaced, reducing environmental impact, and promoting sustainability.

Service, Repair, and Maintenance: The nanogrid system can be engineered for easy serviceability. Key components, such as the battery modules, power electronics (e.g. DCAC), compressors, and other mechanical parts, are designed to be easily accessed, removed, and replaced. This modular approach can be paired with software-enabled detection and early alerting systems that monitor the health of mechanical and power systems. The software can proactively identify potential issues, allowing for timely maintenance or repairs before more significant problems arise. This reduces downtime and extends the system's operational life.

Expandable Power and Energy Capacity: In some embodiments, such as shown in FIG. 2b, a nanogrid system 202 is designed with user-accessible electrical and mechanical connection points to add energy modules. The ability to add or remove battery modules 254 and solar PV MPPT modules 256 provides users with flexibility in managing their power needs during system setup and operation. For instance, users can increase their system's backup power capacity by adding more battery modules, tailoring the system to provide longer-duration backup during outages. Conversely, battery modules can be removed or swapped between devices within an ecosystem of battery-powered products, offering a dynamic way to manage energy resources throughout the home. Power capabilities can also be extended by adding in modules containing solar PV inputs and conversion (i.e. DCDC converters with MPPT functionality) to allow for generation directly connected to the nanogrid for off-grid and on-grid battery charging.

In some embodiments, the nanogrid system is designed with user-accessible electrical and mechanical connection points to add low voltage communication, compute, and sensor modules 260.

Versatility and Ecosystem Integration: The modular design can extend beyond just the nanogrid system itself, encouraging integration with a broader ecosystem of devices. Battery modules, for example, can be shared with other compatible devices, allowing users to optimize their energy storage and usage across multiple applications. This versatility makes the system not just a standalone solution but a key component of a broader, interconnected energy management ecosystem.

The modular design of the system can prioritize safety by incorporating advanced features to enable user protection and reliable operation. Each module can be engineered with touch-safe enclosures and connectors, reducing the risk of accidental contact with live electrical components. All of the power ports/terminals/connectors mentioned in this description can be said to be at least partially “included in” the nanogrid system's enclosure to the extent they each protrude from a surface of the enclosure or are positioned within an opening in a surface of the enclosure.

Presence detection mechanisms can confirm the secure attachment of modules before they become operational, preventing inadvertent disconnection or improper installation. Communication interlocks between modules can enable only compatible units to connect, facilitating the safe exchange of operational data and enhancing system stability and performance. Electrical contact monitoring can continuously check for proper connection integrity, alerting the system to any issues that could compromise safety. For high-voltage DC connections, a pre-charge circuit is employed to gradually build up voltage before full power is applied, minimizing the risk of arcing, and extending the life of the connectors. Additionally, each module can be equipped with overcurrent protection to prevent damage from electrical faults, ensuring that any issue within a module is isolated and does not affect the rest of the system. This comprehensive approach to safety, embedded within the modular architecture, can enable the system to remain robust, secure, and user-friendly across all configurations.

This subsystem modularity can enable the system to remain adaptable, serviceable, and upgradable, providing long-term value to users while supporting sustainable practices.

### Refrigerator and Freezer Nanogrid Systems

Refrigeration is a critical energy use in both residential and commercial settings, essential for ensuring food safety, prolonging the shelf life of perishables, and preserving certain medications. In the event of a power outage, the loss of refrigeration can lead to spoiled food and medicines within hours, resulting in significant financial loss and, in some cases, posing serious health risks. Refrigerators are also among the largest energy consumers in homes and businesses, highlighting the need for energy-efficient solutions applied to these devices.

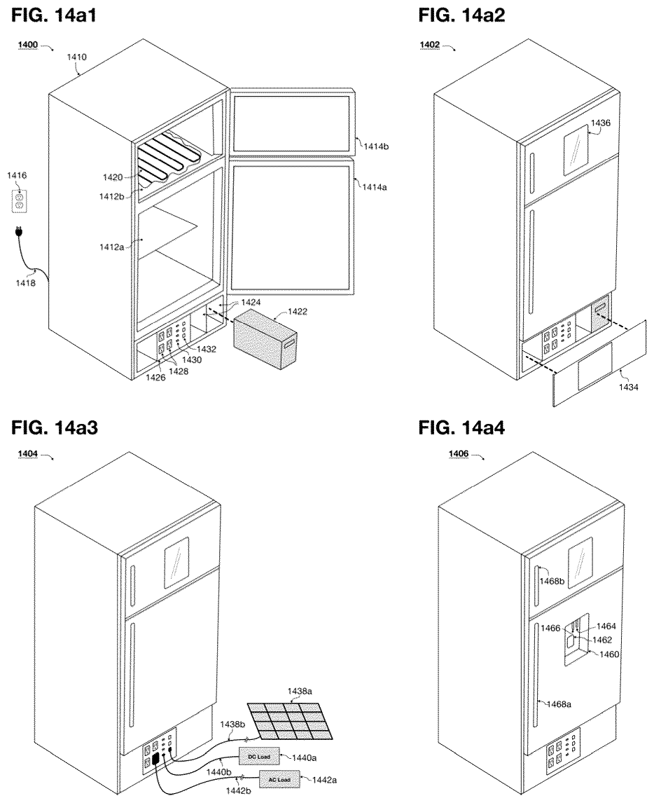

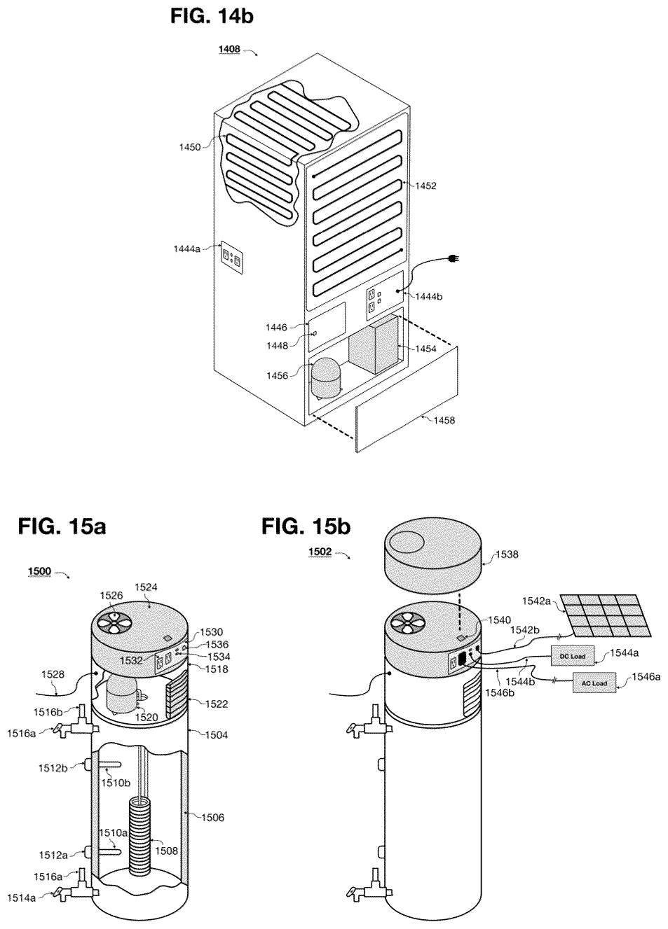

In some embodiments, the nanogrid system is engineered to deliver more reliable, efficient, and resilient refrigeration as illustrated in FIGS. 14a1-14a4 and 14b. This can be accomplished by integrating the nanogrid's power and thermal management systems directly into the design of a refrigerator/freezer appliance, within an integrated self-contained enclosure 1410, 1308a-d. This integration not only enhances the appliance's functionality during power outages but also optimizes energy usage and appliance performance when connected to the grid or building's electrical system.

In these embodiments, the nanogrid-integrated refrigerator system can be designed with one or more refrigerator compartments 1412a-b, each providing an enclosed, refrigerated air space optimized for storing perishable goods. Inside these compartments, shelves and storage bins are arranged to offer convenient access and organization for users, accommodating a variety of items such as food, beverages, and medications.

To provide energy efficiency, the refrigerator system can utilize effective insulation between the compartments and the exterior enclosure walls. This insulation, which may be composed of high-performance foam or vacuum panels, reduces the impact of the ambient environment on the refrigerated compartments, thus reducing the energy required to maintain the desired internal temperatures.

In some embodiments, one or more of the refrigeration compartments are optimized for a temperature range ideal for refrigeration, typically between 34° F. and 40° F. (1° C. to 4° C.). This range is well-suited for preserving the freshness of perishable foods while preventing bacterial growth. Additionally, in other embodiments, one or more compartments are configured for freezer temperatures, generally around 0° F. (−18° C.), for safely storing frozen foods over extended periods. The system allows for temperature adjustments either through the nanogrid's intelligent software, which can optimize settings based on environmental conditions and energy availability, or via user preferences input through the system's interface.

User access to the refrigeration compartments can be facilitated by doors 1414a-b that are hinged for ergonomic use, with handles 1468a-b designed for comfort and ease of operation. To accommodate various physical space constraints and user preferences, the refrigerator system can be produced in any of various styles, such as French doors, top-and-bottom configurations, or as a chest freezer. In some embodiments, the refrigerator is equipped with an auto-closing mechanism for the doors. Depending on the embodiment, the mechanism may be active, utilizing a motorized system to close the door securely after use, or passive, employing gravity, inclined planes, or utilizing air springs to gently close the door and maintain the internal temperature.

The refrigeration loop system, integral to the nanogrid-integrated refrigerator, is a closed-loop thermal system designed to maintain precise temperature control within the refrigerator and freezer compartments. As illustrated in select embodiments in FIGS. 10a-e, the loop includes several key components: a compressor 1456, a condenser coil 1452, an evaporator coil 1420, and associated fans and sensors, all working in concert to regulate the internal environment of the appliance.

The compressor is responsible for compressing the refrigerant, increasing its pressure and temperature as it flows through the loop. The heated refrigerant then passes through the condenser coil, typically located at the back or bottom of the appliance. A stirring fan is used in conjunction with the condenser coil to efficiently dissipate heat into the surrounding environment, facilitating the cooling of the refrigerant before it enters the next stage of the loop. Once cooled, the refrigerant flows to the evaporator coil, located within or adjacent to the refrigerated compartments. Here, it absorbs heat from the air inside the compartments, effectively lowering the temperature to the desired setpoint. This process of heat absorption cools the compartments and maintains the freshness and safety of stored items. The cooled air is then circulated throughout the compartments by fans, ensuring an even distribution of temperature.

To achieve precise control over the refrigeration process, the nanogrid system can incorporate a network of sensors 1358a-d, such as temperature sensors. These sensors are strategically placed inside the refrigeration compartments, monitoring the internal temperature to enable it to be maintained within the set range. Additional sensors may be positioned to measure the ambient temperature outside the appliance, providing data that allows the nanogrid system (e.g. via TMS and AMS software) to adjust its operation based on external conditions. The system also can include sensors distributed throughout the thermal system, monitoring the performance of components like the compressor and evaporator coil. In some embodiments, the system also includes humidity sensors within the refrigeration compartments. These sensors help to maintain desired humidity levels, preventing issues like freezer burn or excessive moisture that could compromise the quality of stored goods. By integrating temperature and humidity sensing with the nanogrid's intelligent software, the system can dynamically adjust its operation to maintain ideal storage conditions while optimizing energy use.

In some embodiments, the nanogrid system includes components for automatic defrost heating 1450 such as via one or a combination of electric resistance heating coil and/or circulating fluid loop thermally coupled to the battery and power electronics system, embedded in the wall of one or more refrigeration compartment(s).

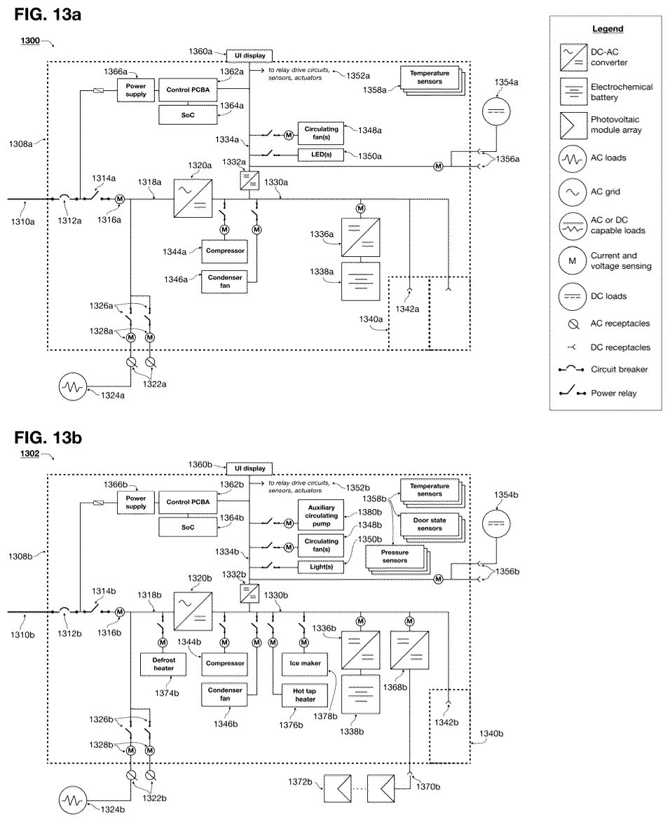

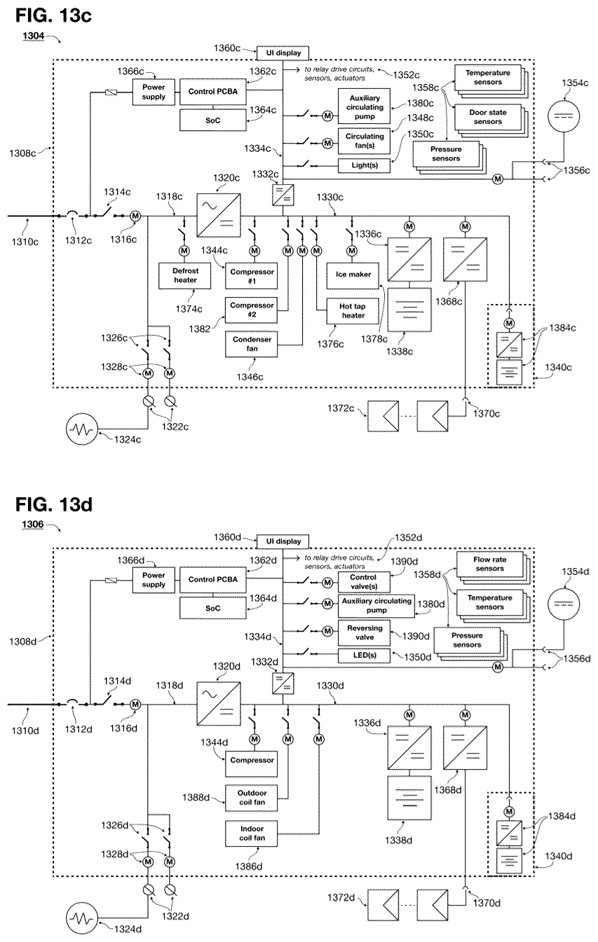

In refrigeration-oriented embodiments, the nanogrid power system is engineered to optimize the efficiency and performance of electrical loads, energy sources, and storage components, ensuring seamless integration with both the appliance and the broader home energy ecosystem. FIGS. 13a-d provide detailed exemplary power system designs—including a basic system approach 1300, approach with additional functionality and thermal integration 1302, and a dual compressor approach 1304—each related to general nanogrid power system designs provided in FIG. 1.

The system connects to premises wiring system via AC power cable and plug assembly 1418, 1310a-d attached securely to the device 1444b, designed to interface with a building electrical receptacle 1416. In some embodiments, the system integrates overcurrent protection at the AC supply input 1312a-d to protect the AC bus 1318a-d. To confer intentional islanding capabilities, the system integrates an MID relay on the AC bus 1314a-d. Power and energy metering is integrated across the AC and DC system to provide detailed measurement of power flow within the system, including at a point representative of energy exchange with the premises distribution system 1316a-d.

FIG. 13 shows a representation of the relevant nanogrid power system elements discussed in detail above in relation to FIG. 1, including bidirectional hybrid multimode inverter (i.e. DCAC converter) 1320a-d, high voltage DC (HVDC) bus 1330a-d, integrated battery energy storage module(s) 1338a-d and bidirectional battery DCDC 1336a-d, integrated DC loads, low-voltage DC (LVDC) bus 1334a-d supplied by a DCDC buck converter 1332a-d to power integrated LVDC loads and electronics including LED lighting 1350a-d, circulating fan(s) 1348a-d, relay drive and sensors 1352a-d, and control circuitry 1362a-d and compute module(s) 1364a-d. To confer additional resiliency and flexibility to the power system and facilitate start-up, the LVDC system is designed to source power directly from the AC bus via a DCAC power supply 1366a-d. The system integrates power monitoring and control for some or all AC and DC loads to allow for effective energy management.

In select refrigeration-oriented embodiments, several of the loads are designed to receive power from the HVDC bus for improved efficiency, including the compressors 1344a-d, 1382, condenser fan 1346a-c, ice maker 1378b-c, and/or hot water tap heating element 1376b-c. In some embodiments, certain internal loads may be connected to the AC bus such as the defrost heating element 1374a-c. In some embodiments, other integrated loads are designed to receive power from the LVDC bus such as circulating fans 1384a-c, user interface display(s) 1360a-d, and/or auxiliary circulating pump(s) 1380a-d.

In some embodiments, the nanogrid system is designed with integrated solar DCDC MPPT converter(s) 1368b-d to allow connecting PV panel(s) 1372b-d, 1438a to the nanogrid appliance system 1404 via power cable(s) 1438b to user-accessible connectors 1370b-d, 1432 hosted on the system.

In addition to the integrated power conversion and battery energy storage system 1454, certain embodiments of the nanogrid system are designed to support user-installation of various power modules 1422, such as battery packs 1384a-d and/or solar photovoltaic (PV) maximum power point tracking (MPPT) modules. These modules are engineered to seamlessly integrate with the appliance system through carefully designed mechanical interaction points 1424, 1340a-d and integrated electrical connectors 1342a-d. These connection points provide a secure and reliable interface between the mechanical components and electrical contacts, facilitating straightforward installation. The design prioritizes both functionality and aesthetics, providing options for modules to be installed in an elegant and unobtrusive manner. In some embodiments, an aesthetic cover 1434 may be employed to further enhance the appearance of the installed modules, ensuring that they blend seamlessly with the overall design of the appliance 1402, 1406 while maintaining ease of access and functionality.

The nanogrid system can feature strategically placed receptacles on user-accessible panel(s) 1426 that enhance flexibility and resilience during power outages as well as for daily energy management usage (i.e. enabled by integrated actuators for granular control 1328a-d and metering circuitry 1326a-d). These receptacles include both AC 1322a-d and DC 1356a-d options, such as NEMA outlets for AC loads 1324a-d, 1440a-b and USB Type-C ports 1430 for DC loads 1354a-d, 1442a-b, accommodating a wide range of devices and appliances. The design of the receptacles prioritizes their location to maximize usability and accessibility. In some embodiments, receptacles are positioned on the front and/or side 1444a of the system to facilitate easy and flexible use for frequently connected devices. Alternatively, in other embodiments, receptacles are located on the rear of the unit, providing a semi-permanent connection option for appliances that benefit from integrated energy management and monitoring. This strategic placement enables users to efficiently manage their energy needs and maintain power resilience across various scenarios.

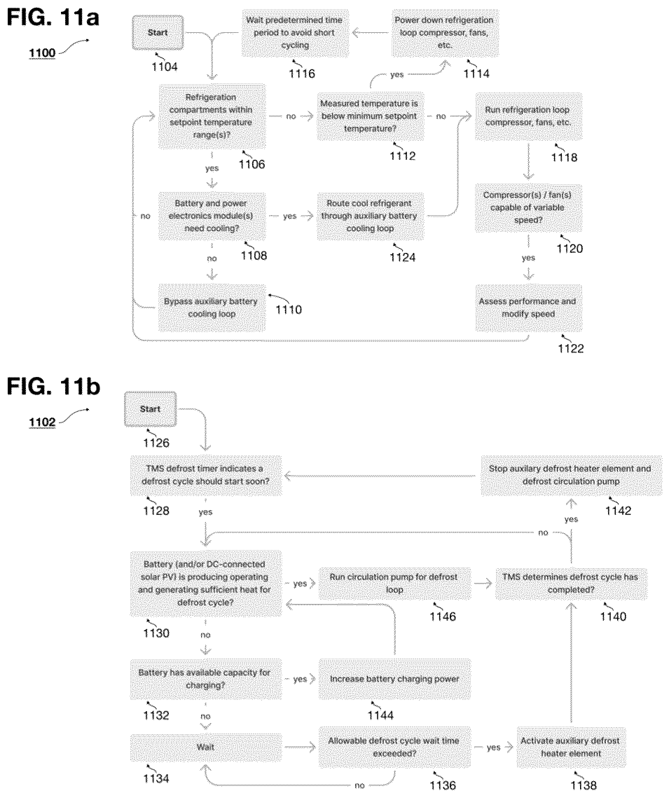

The nanogrid system's integrated design allows for effective thermal management via indirect and/or direct coupling strategies of various components contained in the system, including between the battery and power electronics module and refrigeration compartments and/or refrigeration loop as detailed above and in FIG. 9 and FIG. 10. This unique management functionality is managed by the onboard TMS software. FIG. 11a provides example logic 1100 for providing selective cooling to battery energy storage and power electronics modules based on measured thermal needs. Once this software system initializes 1104, the software system first determines if one or more refrigeration compartments are within their defined setpoint ranges 1106 using integrated temperature sensors. If that condition is true, the system then determines if the integrated battery and electronics module(s) require cooling (i.e. are above a defined temperature setpoint, using integrated temperature sensors) 1108. If that condition is false, the system adjusts control of actuators to cause cooling fluid not to be routed to the cooling loop coupled to the battery and power electronics 1110. However, if this power system does require cooling, the TMS software logic adjusts the thermal system to cause refrigerant to flow through the power system auxiliary cooling loop 1124, and subsequently causes the cooling system to operate (i.e. running one or more compressor(s), pump(s), and/or fan(s) 1118. In some embodiments, one or more of the thermal system's compressor(s), pump(s), and/or fan(s) may be capable of variable speed control, and the TMS determines this based on configuration data 1120, to continually assess thermal performance and modify speed(s) 1122 to cause efficient thermal management to be balanced with efficient use of energy. If the TMS logic determines that refrigeration compartment(s) are not within the temperature setpoint range, the system logic will then consider if the measured temperature of these compartments is below a defined minimum setpoint 1112, and if this condition is false (i.e. one or more of the compartments are warmer than setpoint), the TMS will cause the refrigeration system to operate to cool the system down 1118-1122. Conversely, if the condition is true (i.e. one or more of the compartments are cooler than setpoint range), the TMS will cause the refrigeration loop to cease cooling operation one or more of the compartments are warmer than setpoint 1114 by powering down the refrigeration loop compressor(s), pump(s), and/or fan(s). To avoid short-cycling the thermal system, which may cause undue mechanical wear when starting compressors against high pressure, the TMS is equipped with logic to wait a predetermined time before restarting the cooling system's compressor(s) after shutdown 1116.

Similarly, FIG. 11b depicts an example of the logic 1102, of the TMS for select embodiments, for providing selective defrost heating to refrigeration compartments leveraging system waste heat. Once the TMS software system initializes 1126, it first determines if an automatic defrost cycle should start 1128 based on measured temperatures and predefined time-based heuristics. When this condition is true, the TMS then evaluates whether the battery and/or connected sources (e.g. solar PV) are operating and generating sufficient waste heat from power conversion to selective route that waste heat for defrosting a freezer compartment 1130. If there is not sufficient heat generation from the operation of the battery and/or power conversion system at that time, the TMS may then consider if there is available capacity for charging the battery 1132 and increase battery charging power 1144 to cause more heat to be generated from the battery operation. Once the TMS determines there is heat available from the power system to route for the purposes of defrosting, it causes the defrost circulation pump to run 1146, until the TMS determines the defrost cycle has completed 1140, and when this condition is true, the TMS causes the defrost circulation pump and when applicable the defrost resistive heater element to stop 1142. Else, the TMS continually assesses the available excess heat from the battery and power conversion system available 1130 to make necessary adjustments for efficient operation and effective defrosting. When the TMS determines there is not capacity available to charge the onboard battery (i.e. it is at End of Charge), the TMS may wait 1132-1134 until a maximum wait time has elapsed 1136, at which point the TMS may activate an auxiliary resistive defrost heater element 1138 to enable defrosting to be reliably completed regardless of the state of the battery and power conversion system.

The refrigerator design within the nanogrid system can include several notable features that enhance its functionality, convenience, and user experience. Among these are interior lights, door state sensing, an ice maker, dispensable water taps, and an advanced user interface, all integrated into the appliance to offer a modern, efficient, and user-friendly solution.

Interior Lights: The interior of the refrigerator can be equipped with strategically placed lighting, ensuring that all compartments are well-illuminated when the doors are opened. These lights, which may be LED-based for energy efficiency and longevity, provide clear visibility of stored items, even in low-light conditions. The lighting system is designed to be soft yet bright, enhancing the user experience without generating excess heat that could affect the internal temperature. In some embodiments, the lighting may automatically adjust its intensity based on the time of day or user preferences, adding an extra layer of customization.

Door State Sensing: To further improve energy efficiency and user convenience, the refrigerator can include door state sensors that detect whether the doors are open or closed. These sensors play a crucial role in preventing energy loss by alerting users if a door is left open for an extended period, potentially sending notifications via the appliance's user interface or connected smartphone application. The sensors also interact with the TMS, allowing it to adjust the cooling cycle to compensate for any temperature fluctuations caused by an open door, thus maintaining desired storage conditions.

Ice Maker: The integrated ice maker provides a continuous supply of ice, stored in a dedicated compartment within the freezer section. This feature is designed for convenience, allowing users to access ice without the need for external ice trays. The ice maker operates efficiently within the refrigeration loop, using the system's thermal management capabilities to produce and store ice. In some embodiments, the ice maker may offer different ice sizes or types, such as crushed or cubed, to suit various user preferences.

User Interface: The refrigerator can include an advanced user interface 1436, typically presented through a high-resolution screen, such as an OLED display, located on the door or another accessible area of the appliance. This screen provides users with real-time information on the status of the refrigerator, including temperature settings, door state alerts, and the status of features like the ice maker and water taps. The user interface allows for intuitive control over the appliance's functions, enabling users to easily adjust settings, monitor energy usage, and set preferences for various features. In some embodiments, the interface is also accessible via a companion smartphone or web application, allowing users to manage their refrigerator remotely. This integration of a user-friendly interface with the nanogrid's intelligent software make the appliance both easy to use and highly adaptable to individual needs.

Dispensable Water Taps and Water Filter with Resiliency Features: The refrigerator may include one or more dispensable water taps 1460-1464 connected via an integrated water-tight fitting 1448 to the domestic water supply, offering both convenience and added resiliency in power outages or emergency situations. In the most basic configuration, a single tap allows users to dispense chilled water directly from the refrigerator. In some embodiments, the system features two separate taps for dispensing both hot and cold water, providing additional functionality. Some embodiments also offer the option to dispense carbonated water, utilizing a user-replaceable carbonation cartridge that can be easily installed and replaced as needed. The water supplied through these taps is filtered using an integrated water filter, ensuring that the water is clean and safe for consumption. The filter is designed for easy replacement, maintaining the quality and taste of the water over time.

In certain embodiments, the system is designed to offer additional levels of resilience during power outages and emergency situations. These embodiments include water taps equipped to aid in disinfecting water to make it safe and potable. This can be achieved through various filtering methods, such as UV filtration, filter media, or a combination of techniques effective at removing common waterborne risks to potability, such as bacteria, viruses, and other contaminants. In other embodiments, resiliency is further enhanced by providing the capability to boil water and deliver it via the hot water tap, making it suitable for safe drinking or cooking during emergencies. This functionality is enabled by integrated heating elements, which can connect to either AC or DC voltage buses within the system. By leveraging the nanogrid's power management capabilities, the refrigerator can keep essential water heating and filtration functions operational even during extended outages, providing critical support to users in times of need. In some embodiments, illustrated in FIG. 10d, the domestic water feed 1066d to the hot water tap is designed to be preheated by the refrigeration loop via a heat exchanger 1058d supplemented by an electric heating element 1062d prior to exiting the dispenser tap 1060d.

The design of the nanogrid system can incorporate removable access panels on both the front 1436 and rear 1446, 1458 of the appliance, facilitating easy serviceability and maintenance. These panels provide straightforward access to critical components such as the power system, battery modules, and TMS, enabling technicians to perform routine inspections, repairs, and upgrades with minimal disruption. The front access panel allows for convenient interaction with user-facing elements and power modules, while the rear panel enables unobstructed access to internal wiring and thermal system modules. This design keeps the appliance functional and efficient over its lifespan, while also simplifying the process of addressing any potential issues that may arise.

### Appliance Load Use Cases

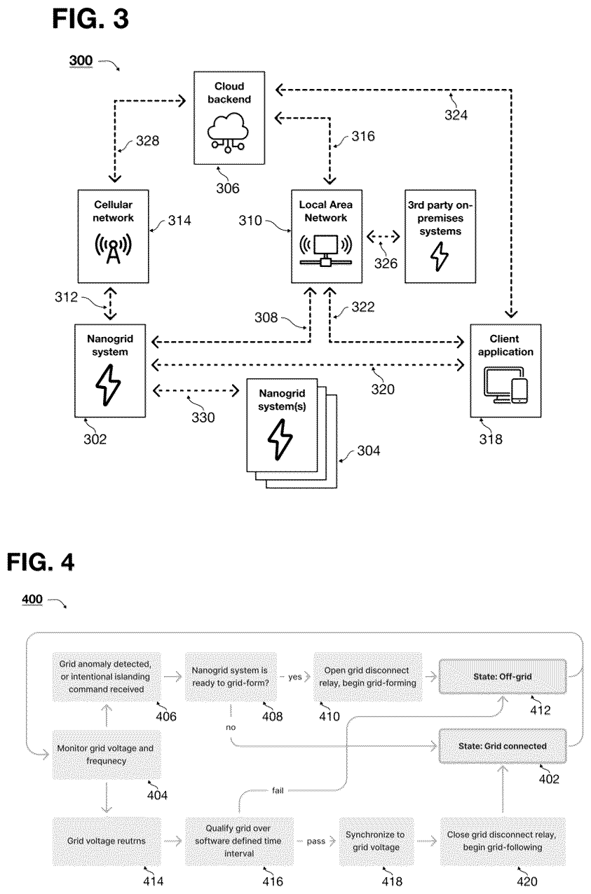

In other embodiments, the integrated nanogrid system is similarly designed to replace traditional home appliances for domestic water heating, space conditioning (i.e. heating, ventilation, and air conditioning, HVAC), or clothes washing and drying while providing new and extensive backup power, energy and power management, and energy system interoperability. The system is designed to provide significant advantages and functionality when multiple nanogrid systems form an ecosystem of products at a home or business as illustrated in FIG. 3 and related discussion above, such as coordinated and comprehensive energy optimization, power management, distributed energy and environmental monitoring, and virtual power plant control, and related software-enabled intelligence discussed in relation to FIGS. 4-8 and 12.

In embodiments designed to provide domestic water heating, as illustrated in FIG. 15, the integrated nanogrid system enables continuous access to hot water even during power emergencies. This is essential for maintaining health, sanitation, hygiene and comfort, as hot water is critical for cooking, cleaning, and personal care. The system utilizes efficient heating elements that can operate on either AC or DC power, drawing directly from the nanogrid's battery storage or solar PV modules when grid power is unavailable. This capability not only supports essential daily activities but also enhances the resilience of households and businesses by ensuring that hot water remains available during outages, contributing to overall safety and well-being in critical situations. Additionally, the system's smart controls allow for optimized energy use, prioritizing hot water availability based on user preferences and demand, ensuring that energy resources are managed efficiently across the nanogrid ecosystem.

In some embodiments, the nanogrid system is designed to provide water heating primarily using one or more electric resistance elements with a storage tank, ensuring a reliable supply of hot water even during power outages. This setup allows for consistent and immediate water heating, with the storage tank maintaining a reserve of hot water to meet household demands. In other embodiments, the system may be configured without a storage tank, utilizing on-demand water heating elements that activate only when hot water is needed, thereby improving energy efficiency by minimizing standby heat losses.

Alternatively, in some embodiments, the nanogrid system 1500-1502 integrates a heat pump heating system with a storage tank, leveraging the energy efficiency of heat pump technology to transfer heat from the surrounding air to the water. This approach significantly reduces the electricity required for water heating, making it an ideal solution for energy-conscious use cases. The storage tank 1504 in this configuration enables a steady supply of hot water while benefiting from the lower energy consumption of the heat pump. The storage tank in the nanogrid system's water heating configuration is designed with high-quality insulation 1506 to minimize heat loss, ensuring that the water remains hot for extended periods while reducing overall energy consumption. This insulation is used for maintaining the efficiency of the system, particularly in scenarios where power is limited or during periods of low energy generation, such as during grid outages or low solar output.

The heat pump system integrated within this water heater configuration is integral to the device, e.g., incorporated into a compartment of the device 1518 that may be serviceable by technicians but is otherwise inaccessible to users, and includes several key components that work together to efficiently transfer heat to the water. The system includes a compressor 1520 that circulates refrigerant through the closed refrigerant loop, a condenser coil 1508 located within the storage tank that releases heat into the water, and an evaporator coil 1522 that absorbs heat from the surrounding air. One or more fans or blowers 1526 are used to move air across the evaporator coil and power system components, enhancing heat absorption from the ambient environment. This process allows the heat pump to heat water using less electricity compared to traditional resistance heating elements, making it an energy-efficient option for households.

In some cases, the system may include one or more immersion resistance heaters 1512a-b within the storage tank. These heaters can supplement the heat pump, providing additional heating power when water demand is high or when rapid recovery is needed to maintain the desired water temperature. This dual-heating approach enables the system to meet peak hot water demands while still benefiting from the efficiency of the heat pump under normal operating conditions.

The tank also features various sensors and components to enable safe and effective operation. Temperature sensors are strategically placed, typically at the upper 1510b and lower sections 1510a of the tank, to monitor water temperature accurately. These sensors allow the system's control software to manage the heating process efficiently, ensuring that water is heated to the desired temperature while avoiding overheating.

The cold-water inlet 1516a is located at the lower section of the tank and is connected to the domestic water supply, allowing for the continuous replenishment of water as it is used. The hot water outlet 1516a is located at the upper section of the tank. The tank also includes a drain valve 1514a at the bottom, which facilitates maintenance tasks such as flushing the tank to remove sediment buildup.

Additionally, the system is equipped with a temperature and pressure relief valve 1516a at the upper section of the tank. This safety feature prevents over-pressurization and potential failure of the tank, as it automatically releases water and pressure if the temperature or pressure within the tank exceeds safe limits. This valve enables the system to operate safely under all conditions, protecting both the appliance and the household.

The nanogrid's onboard power system 100-106, 200-202, 1300 containing the battery energy storage module(s), power electronics, MID and supporting electrical components are designed as an integrated section 1524 of the appliance system. This module, connected to the premises electrical distribution system via an AC wiring supply cordset or conductor set 1528, also hosts a user-accessible control and interface panel 1530 with user interfaces 1536, AC receptacles 1532 for connecting AC loads 1546a via a plug-in power cord 1546b, and DC receptacles 1534 for connecting DC loads 1544a via a plug-in power cord 1544b. In some embodiments, the system is designed for modular connection of additional battery storage modules 1538 such as via a blind-mate electrical connector system 1540, as well as connection of solar PV panel(s) 1542a via wired connection 1542b to the system. These design elements enable seamless integration of the nanogrid's power system with existing electrical infrastructure while providing flexible connectivity for both AC and DC loads. The modularity allows for easy expansion of battery storage and the incorporation of solar PV panels, enhancing the system's resilience and energy efficiency.

In some embodiments, integrated thermal strategies between the water and heat pump system provide efficient temperature management of the battery and power electronics system, leveraging one or more strategies including indirect thermal coupling to the evaporator coil 902, 1000 for cooling, direct coupling via an auxiliary refrigeration loop 1002, 1008, and/or heat exchange with the open-loop water flow system 1012.

By offering these various configurations, the nanogrid system provides flexible and resilient water heating solutions tailored to different household needs and energy efficiency goals.

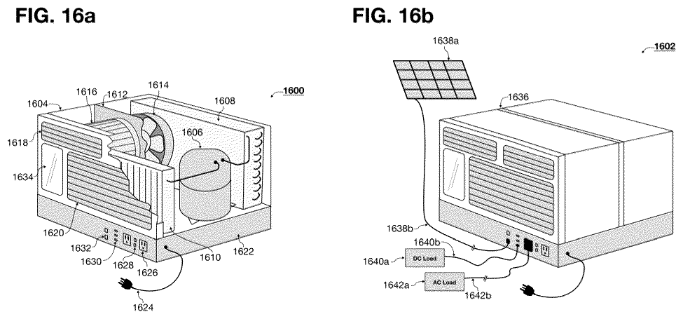

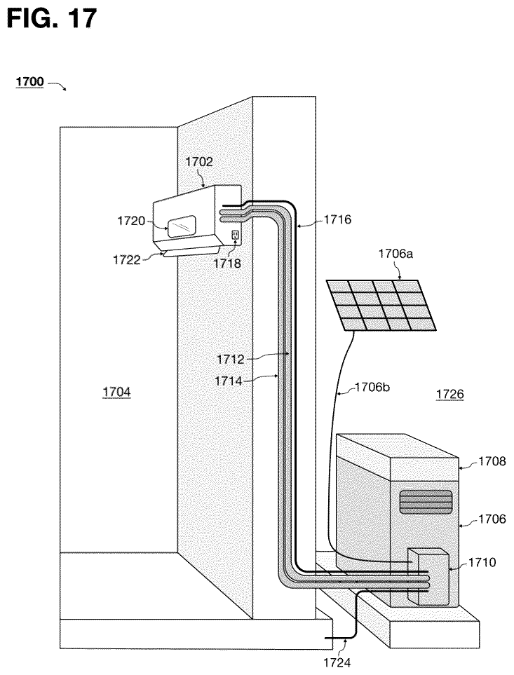

In embodiments designed for space conditioning (HVAC), the integrated nanogrid system offers substantial benefits over traditional heating, ventilation, and air conditioning systems, especially during power emergencies. As shown in FIGS. 16 and 17, the system seamlessly integrates with the home or business's existing infrastructure, allowing for precise temperature and humidity control even during outages. The HVAC system, being one of the largest energy consumers in a building, presents significant opportunities for energy optimization and management. By intelligently managing this load, the nanogrid system not only enhances resilience and reduces energy consumption within the premises but also contributes to grid-scale value by participating in demand response programs and other grid services. This integration enables the system to maintain critical HVAC functions, such as heating and cooling, even when grid power is unavailable, while also playing a pivotal role in a coordinated energy strategy within a broader ecosystem of interconnected nanogrid systems.

In some embodiments, the nanogrid system is designed as a window unit air conditioner or heat pump 1600-1602, integrated into a single mechanical package 1604 that is designed to be easily mounted in-wall or in a window using mechanical connection flanges 1636, and designed to provide space conditioning when grid connected or in power outages by intaking ambient air 1620 and blowing conditioned air 1618 to an indoor space, with an internal partition barrier 1612 to separate the internal and external facing sections of the device. This design allows for easy installation and operation, making it an ideal retrofit solution for homes or businesses seeking to enhance energy resilience and efficiency without requiring significant alterations to existing infrastructure. In other embodiments, such as shown in FIG. 17, the system is designed as a mini-split HVAC system 1700, including a separate indoor unit 1702 and outdoor unit 1706 connected with field-installed send 1712 and return 1714 refrigerant lines, and electrical power cable assembly containing AC and DC power and communication wiring 1716, thereby designed to provide space conditioning when grid connected or in power outages by intaking ambient air and blowing conditioned air 1722 to an indoor space 1704. This configuration offers greater flexibility in installation, allowing for more precise placement of the cooling and heating elements to optimize performance and energy usage. Both designs enable the nanogrid system to manage space conditioning loads effectively, providing reliable temperature control and energy savings even during grid outages.

In some embodiments, the thermal system includes a closed-loop refrigeration cycle that comprises components such as a compressor 1606, evaporator coil 1610, condenser coil 1608, evaporator fan 1616, condenser fan 1614, and expansion valve. This system is primarily designed to provide cooling to an interior space, efficiently maintaining desired temperatures within the conditioned environment. In these embodiments, integrated thermal strategies with the heat pump system provide efficient temperature management of the battery and power electronics system, leveraging one or more strategies including indirect thermal coupling to the evaporator coil 902, 1000 for cooling the power system elements, and/or direct coupling via an auxiliary refrigeration loop 1002, 1008.

In other embodiments, the nanogrid system is configured as a heat pump, capable of delivering both heating and cooling to the conditioned area. This can be achieved by incorporating additional components into the refrigeration loop system as illustrated in FIG. 10f. In a heat pump system, this basic refrigeration cycle is enhanced to allow for reversible operation, enabling both heating and cooling modes. To achieve this, additional components such as a reversing valve are included. The reversing valve alters the direction of the refrigerant flow, allowing the condenser coil and evaporator coil to switch roles depending on whether heating or cooling is required. In heating mode, the evaporator coil absorbs heat from the outside environment (even in cold weather), and the condenser coil releases this heat into the indoor space. This ability to reverse the cycle makes heat pumps versatile, providing efficient space heating in addition to cooling. This versatile design enables the nanogrid system to adapt to varying climate control needs, ensuring comfort and energy efficiency in different environmental conditions. In such embodiments, integrated thermal strategies with the heat pump system and the battery and power electronics system are designed to leverage one or more thermal strategies including indirect thermal coupling to the evaporator coil 902, 1000 for cooling the power system elements, and/or direct coupling via an auxiliary refrigeration loop 1010.

In some embodiments, the system includes air filtration features with a user-replaceable filter. This filtration system is designed to enhance indoor air quality by capturing dust, pollen, and other airborne particles. The user-replaceable filter enables easy maintenance and allows users to regularly replace the filter as needed, promoting high system performance and ensuring a healthier living environment.

In these embodiments, the nanogrid system is electrically connected with the AC premises distribution system via a power cord and plug assembly 1624 or set of electrical conductors 1724 run during installation to an interconnection module 1710 on the system.

The nanogrid's onboard power system 100-106, 200-202, 1300, 1306 containing the battery energy storage module(s), power electronics, MID and supporting electrical components are designed as an integrated section 1622, 1708 of the appliance system. The system hosts user interfaces including a display(s) 1632-1634, 1720, AC receptacles 1626, 1718 for connecting AC loads 1642a via a plug-in power cord 1642b, and DC receptacles 1630 for connecting DC loads 1640a via a plug-in power cord 1640b. In some embodiments, the system is designed for modular connection of solar PV panel(s) 1638a, 1706a via wired connection 1638b, 1706b to dedicated connector receptacles 1628 on the system. These design elements provide seamless integration of the nanogrid's power system with existing electrical infrastructure while providing flexible connectivity for both AC and DC loads. The modularity allows for easy expansion of battery storage and the incorporation of solar PV panels, enhancing the system's resilience and energy efficiency.

In some embodiments, the system is designed with a modular, user-replaceable auxiliary battery to supplement the integrated battery. This auxiliary battery can be easily installed or swapped by the user, providing additional energy storage capacity when needed, such as during extended power outages or periods of high energy demand. This modular approach not only enhances the system's resilience and flexibility but also allows users to tailor the energy storage capacity to their specific needs, ensuring uninterrupted operation of critical systems and appliances.

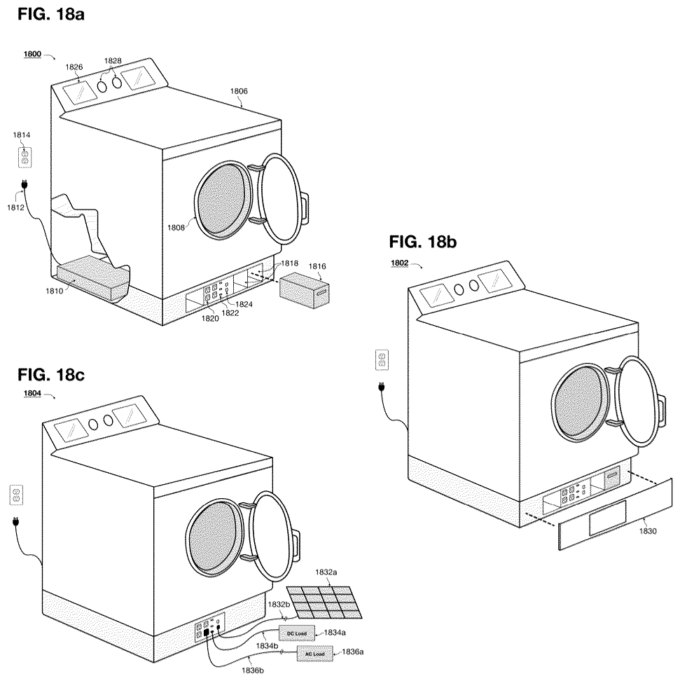

In embodiments designed for clothes washing and/or drying, the integrated nanogrid system provides enhanced resiliency and energy management, offering significant benefits during power outages and daily operations. As illustrated in FIG. 18, the system integrates seamlessly with traditional laundry appliances, allowing users to continue washing and drying clothes even when grid power is unavailable. This is particularly important for maintaining hygiene and convenience during extended outages. Additionally, because laundry appliances are substantial energy consumers, the nanogrid system optimizes their operation for energy efficiency. By managing the power consumption of washing machines and dryers, the system not only reduces energy usage within the premises but also contributes to broader energy management goals, such as load shifting and participation in grid services. This enables critical laundry functions to be maintained with minimal energy expenditure, providing a resilient and convenient solution that enhances both household efficiency and grid stability.

The mechanical design of the integrated nanogrid system for clothes washing and/or drying 1800-1804 is structured as an integrated enclosure 1806 and system of power modules 1816, prioritizing both functionality and ease of service. In some embodiments, the system is designed to accommodate various types of laundry appliances, such as top-loading or front-loading washing machines, and vented or ventless dryers. In each of these embodiments, the design includes a drum 1808 for agitating during washing and/or drying with latching access door(s), a heating element for air and/or water to enable efficient cleaning and drying cycles, as well as additional components typical of washer-dryer systems such as water inlets, pumps for draining, lint filters, and user-friendly control panels for selecting various wash and dry settings. These elements are integrated with the nanogrid system to optimize energy use and provide reliable performance even during power outages. The design also considers aesthetics, featuring intuitive user interfaces 1826-1828 and sleek covers for serviceable areas and module connections ensuring that the system blends seamlessly with modern home interiors while providing easy access for maintenance and upgrades.

The nanogrid's onboard power system 100-106, 200-202, 1300 containing the battery energy storage module(s), power electronics, MID and supporting electrical components are designed as an integrated section 1810 of the appliance system. This power system is designed to be connected to the premises electrical distribution system 1814 via an AC wiring supply cordset or conductor set 1812. The system hosts AC receptacles 1820 for connecting AC loads 1836a via a plug-in power cord 1836b, and DC receptacles 1822 for connecting DC loads 1834a via a plug-in power cord 1834b. In some embodiments, the system is designed for modular connection 1824 of solar PV panel(s) 1832a via wired connection 1832b to the system. These design elements provide seamless integration of the nanogrid's power system with existing electrical infrastructure while providing flexible connectivity for both AC and DC loads. In addition to the integrated power conversion and battery energy storage system, some embodiments of the system support user-installation of various power modules 1816, such as battery packs 1384a-d and/or solar photovoltaic (PV) maximum power point tracking (MPPT) modules. These modules are engineered to seamlessly integrate with the appliance system through carefully designed mechanical interaction points 1818, 1340a-d and integrated electrical connectors 1342a-d ensuring secure and reliable interface between the mechanical components and electrical contacts and facilitating straightforward installation. The design prioritizes both functionality and aesthetics, providing options for modules to be installed in an elegant and unobtrusive manner. In some embodiments, an aesthetic cover 1830 may be employed to further enhance the appearance of the installed modules, ensuring that they blend seamlessly with the overall design of the appliance while maintaining ease of access and functionality.

In some embodiments, the nanogrid's thermal system is designed to provide heating to the internal drum and/or air and water intakes to enable effective washing and drying cycles. This heating can be achieved using a one or a combination of electric resistance heaters and a heat pump condensing coil controlled by the AMS and TMS, allowing for efficient and adaptable temperature control. The integration of these heating elements helps optimize performance and energy usage, ensuring that both washing and drying functions are maintained at desired levels, even during power interruptions. In embodiments employing a heat pump system integrated thermal strategies with the nanogrid's power system (i.e. battery and/or power electronics modules) is designed to leverage one or more efficient heat transfer strategies including indirect thermal coupling to the evaporator coil 902, 1000 for cooling, direct coupling via an auxiliary refrigeration loop 1002, 1008, and/or heat exchange with the open-loop water flow system 1012.

Hence, the detailed description above describes, among other things, a self-contained nanogrid system comprising:
A connection to a power source within the premises, the primary power source.
An MID configured to selectively disconnect from the primary power source
An AC electrical bus.
One or more DC electrical busses
A bidirectional, multimode inverter (DCAC)
Battery energy storage modules with an associated battery management system
At least one integrated electrical load
at least one power management component configured to provide backup power to one or more loads within a portion of the nanogrid system
A processor, memory equipment, and programmable software system

The nanogrid system may include one or more solar photovoltaic (PV) inputs which are:
performance optimized using maximum power point tracking (MPPT) algorithms and one or more controllable DCDC converters, and/or
Designed with user accessible electrical connectors for connecting a single or a string of PV panels

The nanogrid system may include a modular power system:
Which supports attachment of one or more user-replaceable battery modules to increase battery storage capacity
For attachment of one or more PV MPPT converter module
Designed for simple service and repair of internal power components and load components

The nanogrid system may include one or a plurality of internal DC loads:
Such as motor and compressor loads
Which are designed to be powered from the shared DC bus with battery energy storage and/or solar PV
Which may be enabled with variable speed control for improved power control, improved energy efficiency, and improved user experience such as reduced noise during operation

The nanogrid system may include an integrated thermal strategy:
Between one or more integrated loads,
Between the power system (such as the battery and power conversion system),
And ambient air, and/or a domestic water supply
Which may be designed as one or combination of active (for example a blower fan and/or a refrigeration loop) or passive (for example conductive or convective) thermal management strategies

The nanogrid system may host user-accessible AC and DC power receptacles:
Which are designed to provide power in an outage (i.e. on loss of the primary power source), or when grid-connected
For powering one or more adjacent user-connected AC loads
For powering one or more adjacent user-connected DC loads
For connecting one or more user-connected solar PV panel or strings of panels, or battery modules
Which are designed for easy user access during operation
Which may include energy metering and power control at the outlet level

The nanogrid system may include a bidirectional inverter (DC-AC converter) which:
Is of a hybrid multimode design capable of configurable grid-following and grid-forming operation
Is designed for programmable output AC voltage, frequency, power factor, phase, and current
Is designed to efficiently/effectively power onboard and connected loads including delivering inrush current associated with integrated and user-connected load startup
Is designed for grid interoperability, in particularly capable of Smart Inverter functionality such as Frequency-Watt Control, Voltage-Watt Control, Reactive Power Control (Volt-Var Control), Peak Shaving, Energy Storage Management, Demand Response, Remote Monitoring and Control, Data Logging and Reporting, Frequency Regulation

The nanogrid system may include one or more intuitive user interfaces:
Designed as an integrated component of the system, such as screen and/or LED indicator(s)
Which may be accessed via a smartphone app
Which may be accessed via a web app

The nanogrid system can replace a traditional (i.e., non-nanogrid-enabled) residential appliance:
Having an integrated enclosure or set of enclosures designed to be connected electrically
Which may contain refrigeration loop and/or heat pump system
Which may be a refrigerator, or combined refrigerator-freezer appliance
Which may be a space conditioning appliance (such as to provide space heating, ventilation, and/or cooling, HVAC)
Which may be a water heating appliance
Which may be a clothes washing and/or drying appliance

For systems designed as refrigeration/freezer appliances, the nanogrid system may include:
May have one or more temperature controlled compartments
Integrated thermal strategy may be used to cool the battery and power electronics system
Integrated thermal strategy may be used for defrost

For systems designed as HVAC appliances, the nanogrid system may include:
An integrated thermal strategy may be used to selectively cool the battery and power electronics system
May be designed to selectively provide cooling to an interior space
May leverage reversible heat pump design to provide configurable cooling or heating to an interior space

For systems designed as water heating appliances, the nanogrid system may include:
An integrated thermal strategy may be used to selectively cool the battery and power electronics system
The system may leverage one or both of a refrigeration loop (heat pump) design and electric resistance heater design to provide water heating

The nanogrid system may include software-enabled methods allowing the nanogrid system to:
Coordinate with other on-premises nanogrid systems (e.g. to coordinate power exchange with the premises electrical distribution system)
Communicate to on-premises microgrid (i.e. to a 1st or 3rd party MCS and/or EMS to coordinate energy and power capacity and selectively change state of one or more of the connected and integrated loads, sources, and/or battery storage to maintain stable voltage and extend backup time duration)
Maintain internet connectivity (e.g. cellular connection for use in a power outage)
Connect to and communicate with remote sensors and actuators located on the associated premises systems:

The nanogrid system may include one or more wireless communication
To maintain a software connection to the Internet (1st and 3rd party backend software systems) via Wi-Fi
To maintain a software connection to other nanogrid systems on premises
To maintain a software connection to other building systems on premises

The nanogrid system may include MCS software which:
Monitors the AC connection to the primary power source (such as the premises AC distribution connection point which may be via an electrical receptacle or other wired electrical connection)
Automatically disconnects (that is, intentionally islands) and provides seamless backup power via the nanogrid system's MID in event of power anomalies
Uses information from the associated appliance/loads to modify power

The nanogrid system may include EMS software which:
Uses information from the appliance/loads to selectively modify power of battery/solar/loads
Monitors and stores appliance performance and builds performance models to assess likelihood of electromechanical component wear-out failure
Contains algorithms for energy management and optimization in relation to utility tariffs, solar self consumption,
Modifies power and energy management strategies while intentionally islanded to improve backup time and maintain stability of the islanded nanogrid

The nanogrid system may include AMS software which:
Executes self diagnosis routines
Carries out prediction of component issues, such as from wear-out failure
Emits alerts via onboard UI, app, or API
Gathers system data from one or more sensors for Failure detection, prediction, notification, anomaly alerting

What is claimed is:

1. A self-contained nanogrid system comprising:
a power supply input to receive power from a primary power source that is within a premises and external to the self-contained nanogrid system;
a switch coupled to selectively connect or disconnect the self-contained nanogrid system from the primary power source;
a battery to provide backup power when power from the primary power source is not available;
a direct current (DC) power bus coupled to the battery;
an alternating current (AC) power bus coupled to the power supply input via the switch;
a bidirectional inverter coupled between the AC power bus and the DC power bus;
an integrated load coupled to receive power from one of the AC power bus or the DC power bus;
a power output to provide power from one of the AC power bus or the DC power bus to an external load external to the nanogrid system within the premises;
a processing unit, including at least one programmable processor and memory, configured to control operations of the self-contained nanogrid system, including operation of the switch; and
a housing containing the switch, the battery, the DC power bus, the AC power bus, the bidirectional inverter, the integrated load and the processing unit, and at least partially containing the power supply input and the power output.

2. The self-contained nanogrid system of claim 1, further comprising an appliance designed for use in a residential premises, wherein the housing further contains the appliance.

3. The self-contained nanogrid system of claim 2, wherein the appliance comprises at least one of: a refrigerator, a freezer, an air conditioner or a water heater.

4. The self-contained nanogrid system of claim 2, further comprising:
a thermal management system, implemented at least in part by the processing unit, to provide collective thermal management of the appliance and one or more other components of the self-contained nanogrid system, such that a heat dissipative property of the appliance is used to dissipate heat produced by the one or more other components.

5. The self-contained nanogrid system of claim 1, wherein the bidirectional inverter is controllable to operate in a plurality of modes, including a grid-forming mode and a grid-following mode.

6. The self-contained nanogrid system of claim 1, wherein the integrated load is coupled to receive power from the AC power bus, the nanogrid system further comprising a second integrated load coupled to receive power from the DC power bus.

7. The self-contained nanogrid system of claim 1, wherein the integrated load is coupled to receive power from the DC power bus, the nanogrid system further comprising a second integrated load coupled to receive power from the AC power bus.

8. The self-contained nanogrid system of claim 1, further comprising a solar photovoltaic input, coupled to the DC power bus, to receive power from a photovoltaic array external to the nanogrid system and coupled to provide the power from the photovoltaic array to the DC power bus.

9. The self-contained nanogrid system of claim 1, wherein the nanogrid system is configured to receive modular physical attachment of at least one of:
a user-replaceable battery module; or
a photovoltaic maximum Power Point Tracking (MPPT) converter module.

10. The self-contained nanogrid system of claim 1, wherein the integrated load comprises a motor or compressor.

11. The self-contained nanogrid system of claim 1, wherein the processing unit is configured to control thermal management of at least the battery and the integrated load collectively.

12. The self-contained nanogrid system of claim 1, further comprising:
a refrigeration or cooling appliance; and
a heat transfer mechanism designed to transfer heat between the battery and the refrigeration or cooling appliance.

13. The self-contained nanogrid system of claim 1, wherein the heat transfer mechanism comprises an active heat transfer element.

14. The self-contained nanogrid system of claim 1, further comprising:
a first user-accessible power receptable coupled to the AC power bus, to provide AC power to a first user-connected load connected externally to the nanogrid system; and
a second user-accessible power receptable coupled to the DC power bus to provide DC power to a second user-connected load connected externally to the nanogrid system.

15. The self-contained nanogrid system of claim 1, further comprising:
a communication interface configured to implement a wireless connection between the nanogrid system and a second nanogrid system within the premises.

16. The self-contained nanogrid system of claim 15, wherein the nanogrid system is configured to communicate with the second nanogrid system via the communication interface to perform or cause at least one of:
communicating with a microgrid within the premises to coordinate energy and power management of one or more batteries and one or more connected loads;
maintaining internet connectivity; or
communicating with remote sensors or actuators located within the premises.

17. The self-contained nanogrid system of claim 1, wherein the processing unit is configured to:
monitor AC power received at the power supply input; and
control the switch to automatically disconnect the nanogrid system from the primary power source in event of a power anomaly of the AC power received at the power supply input.

18. The self-contained nanogrid system of claim 1, wherein the processing unit is configured to:
receive information from a connected load; and
selectively modify power provided by the battery or another backup power source connected to the nanogrid system, based on the information received from the connected load.

19. The self-contained nanogrid system of claim 1, wherein the processing unit is configured to:
monitor appliance performance information of an appliance connected as an external load to the nanogrid system;
dynamically determine, based on the appliance performance information, a power and energy management strategy while a nanogrid of the nanogrid system is intentionally islanded; and
execute the power and energy management strategy to improve a duration of backup power availability and maintain stability of the nanogrid.

20. A self-contained nanogrid system comprising:
an enclosure;
a power supply input, at least partially contained within the enclosure, to receive power from a primary power source that is within a premises and external to the self-contained nanogrid system;
a relay contained within the enclosure and coupled to selectively connect or disconnect the self-contained nanogrid system from the primary power source;
a direct current (DC) power bus contained within the enclosure;
an alternating current (AC) power bus contained within the enclosure coupled to the power supply input via the relay;
a bidirectional inverter contained within the enclosure and coupled between the AC power bus and the DC power bus;
a battery, contained within the enclosure and coupled to the DC power bus, to provide backup power when power from the primary power source is not available;
a solar photovoltaic input, at least partially contained within the enclosure and coupled to the DC power bus, to receive power from a photovoltaic array external to the nanogrid system;
an AC load contained within the enclosure and coupled to receive power from the AC power bus;
a DC load contained within the enclosure and coupled to receive power from the DC power bus;
an AC power output, at least partially contained within the enclosure, to provide power from the AC power bus to an external AC load external to the nanogrid system within the premises;
a DC power output, at least partially contained within the enclosure, to provide power from the DC power bus to an external DC load external to the nanogrid system within the premises; and
a processing unit, contained within the enclosure and including at least one programmable processor and memory, configured to control operations of the self-contained nanogrid system, including to control operation of the relay in response to a detected anomaly of the primary power source.

21. A self-contained nanogrid system comprising:
an enclosure;
a power supply input, at least partially contained within the enclosure, arranged to receive power from a primary power source that is within a premises and external to the self-contained nanogrid system;
a switch contained within the enclosure and coupled to selectively connect or disconnect the self-contained nanogrid system from the primary power source;
a direct current (DC) power bus contained within the enclosure;
an alternating current (AC) power bus contained within the enclosure coupled to the power supply input via the switch;
a bidirectional inverter contained within the enclosure and coupled between the AC power bus and the DC power bus;
a battery, contained within the enclosure and coupled to the DC power bus;
an integrated load contained within the enclosure and coupled to receive power from one of the AC power bus or the DC power bus;
a power output, at least partially contained within the enclosure, arranged to provide power from at least one of the AC power bus or the DC power bus to a load external to the nanogrid system within the premises; and
a processing unit, contained within the enclosure and including at least one programmable processor and memory, configured to
detect an anomaly of the primary power source and control operation of the switch in response to detection of the anomaly,
manage charging and discharging of the battery, and
coordinate power usage by a plurality of loads housed within and/or connected externally to the nanogrid system, by selectively changing a power state of at least one of the plurality of loads.

22. The self-contained nanogrid system of claim 21, further comprising an appliance that provides a cooling function, wherein the processing unit is further configured to control thermal management of the appliance and one or more other components of the self-contained nanogrid system.

23. The self-contained nanogrid system of claim 22, wherein the processing unit is further configured to control the thermal management by causing a heat dissipative property of the appliance to be used to dissipate heat produced by the one or more other components.

24. The self-contained nanogrid system of claim 21, a solar photovoltaic input, at least partially contained within the enclosure and coupled to the DC power bus, to receive power from a photovoltaic array external to the nanogrid system.
